(19) United States
(12) Patent Application Publication
(10) Pub. No.: US 2024/0192098 A1
(43) Pub. Date: Jun. 13, 2024

(54) METHODS, DEVICES, AND APPARATUS FOR WASHING SAMPLES

(71) Applicant: CURIOX BIOSYSTEMS CO., LTD., Seoul (KR)

(72) Inventors: Namyong KIM, Seoul (KR); Kong Leong CHENG, Singapore (SG)

(21) Appl. No.: 18/286,986

(22) PCT Filed: Apr. 12, 2022
(86) PCT No.: PCT/IB2022/053448

§ 371 Date: Oct. 13, 2023

Related U.S. Application Data
(60) Provisional application No. 63/174,451, filed on Apr. 13, 2021.

(51) Int. Cl. G01N 1/34

(52) U.S. Cl. CPC G01N 1/34

(57) ABSTRACT

An apparatus includes a dispenser with a dispenser nozzle for dispensing a wash liquid to a sample liquid; a dispenser actuator coupled with the dispenser nozzle; one or more processors; and memory storing instructions for sending one or more signals to the dispenser actuator for placing a tip of the dispenser nozzle in contact with the sample liquid at a location adjacent to a top liquid surface of the sample liquid for dispensing the wash liquid through the dispenser nozzle. Methods and devices for washing samples are also described.

### RELATED APPLICATIONS

This application claims the benefit of, and priority to, U.S. Provisional Patent Application Ser. No. 63/174,451, filed Apr. 13, 2021, which is incorporated by reference herein in its entirety.

### TECHNICAL FIELD

This application relates generally to methods, devices, and apparatus for washing samples (e.g., cells, particles, etc.), and more particularly to methods, devices, and apparatus for washing samples on plates.

### BACKGROUND

An array plate is also called a plate, microtiter plate, microplate, or microwell plate. Array plates are typically used to hold respective liquid droplets separately for biological and/or chemical reaction. For example, a well-type array plate includes a plurality of wells so that each liquid droplet or each sample may be dispensed into a separate well for further processing. Typically, the number of wells is selected from 6, 24, 96, 384, 1536, 3456, and 9600.

Samples (e.g., cells) are frequently washed in many biological processes and assays. Washing samples typically involves adding a wash solution to a sample solution, including samples (e.g., cells), and removing the mixture of the wash solution and the sample solution. By repeating the dilution and partial removal of the sample solution, the concentration of chemicals and/or biological reagents other than the samples are reduced. However, variations in the sample washing increase measurement errors, which are not desirable for accurate assays.

In addition, certain cells (e.g., suspension cells, non-adherent cells, and weakly adherent cells) do not strongly adhere to the plate. Thus, during removal of the mixture, cells may be removed along with the mixture, thereby reducing the number of cells that remain on the plate. Because a reliability of cell-based reactions typically requires a sufficient number of cells, the loss of cells during washing negatively affects cell-based reactions.

### SUMMARY

Accordingly, there is need for methods, devices, and apparatus that provide improved accuracy and reduced time in washing cells. Such methods, devices, and apparatus plates may replace the conventional methods, devices, and apparatus for washing cells. In addition, such methods, devices, and apparatus may better retain cells during washing, and reduce or eliminate the loss of cells during washing, thereby improving the reliability of cell-based reactions. Similarly, such methods, devices, and apparatus may be used in washing other types of samples, such as beads or particles conjugated with target molecules.

A number of embodiments that overcome the limitations and disadvantages of existing methods, devices, and apparatus are presented in more detail below. These embodiments provide methods, devices, and apparatus for washing a sample in a solution.

As described in more detail below, in accordance with some embodiments, an apparatus for washing a sample in a sample liquid in a well on a plate includes a dispenser with a dispenser nozzle for dispensing a wash liquid to the sample liquid: a dispenser actuator coupled with the dispenser nozzle: one or more processors: and memory storing instructions for execution by the one or more processors, the stored instructions including instructions for sending one or more signals to the dispenser actuator for placing a tip of the dispenser nozzle in contact with the sample liquid at a location adjacent to a top liquid surface of the sample liquid for dispensing the wash liquid through the dispenser nozzle.

In accordance with some embodiments, a method includes placing a tip of a dispenser nozzle in contact with a sample liquid at a location adjacent to a top liquid surface of the sample liquid while a dispenser dispenses a wash liquid through the dispenser nozzle to the sample liquid.

In accordance with some embodiments, a device includes a first chamber: a first one-way valve in fluidic communication with the chamber for allowing a liquid flow into the first chamber through the first one-way valve and restricting a liquid flow out of the first chamber through the first one-way valve: and a second one-way valve in fluidic communication with the chamber for allowing a liquid flow out of the first chamber through the second one-way valve and restricting a liquid flow into the first chamber through the second one-way valve.

In accordance with some embodiments, a method includes moving a liquid into a first chamber through a first one-way valve: and moving at least a portion of the liquid out of the first chamber through a second one-way valve.

In accordance with some embodiments, a device includes a plate with one or more wells for holding sample solutions, the plate having a top surface and a bottom surface. A bottom surface of a respective well of the one or more wells is substantially flat. A portion of the plate adjacent to the bottom surface of the respective well is substantially transparent.

In accordance with some embodiments, a method includes obtaining any device described herein. The device includes a sample solution in a well that is defined in the device. The method also includes dispensing a wash solution into the well and aspirating a solution from the well so that one or more samples in the sample solution are washed.

In accordance with some embodiments, a method includes obtaining any device with a substantially transparent substrate described herein, and obtaining an image of a sample in the device through the substantially transparent substrate.

In accordance with some embodiments, an apparatus includes a first dispenser defining a first chamber. The first dispenser includes a first nozzle coupled with the first chamber, and a first one-way valve in fluidic communication with the first chamber for allowing a liquid flow out of the first chamber through the first one-way valve and restricting a liquid flow into the first chamber through the first one-way valve. The apparatus also includes a dispenser pump in fluidic communication with the first chamber to provide liquid into the first chamber.

In accordance with some embodiments, an apparatus includes a first aspirator defining a first chamber. The first aspirator includes a first nozzle coupled with the first chamber, and a first one-way valve in fluidic communication with the first chamber for allowing a liquid flow into the first chamber through the first one-way valve and restricting a liquid flow out of the first chamber through the first one-way valve. The apparatus also includes an aspirator pump in fluidic communication with the first chamber to move liquid from the first chamber.

In accordance with some embodiments, a method includes dispensing a first volume of liquid from a first dispenser. The first dispenser defines a first chamber and includes a first piston configured to slide at least partially within the first chamber, a first nozzle coupled with the first chamber, and a first one-way valve in fluidic communication with the first chamber for allowing a liquid flow out of the first chamber through the first one-way valve and restricting a liquid flow into the first chamber through the first one-way valve. The first volume of liquid is dispensed from the first dispenser by moving the first piston. The method also includes dispensing a second volume of liquid from the first dispenser using a dispenser pump in fluidic communication with the first chamber to provide liquid into the first chamber. The second volume is distinct from the first volume.

In accordance with some embodiments, a method includes aspirating a first volume of liquid with a first aspirator. The first aspirator defines a first chamber and includes a first piston configured to slide at least partially within the first chamber, a first nozzle coupled with the first chamber, and a first one-way valve in fluidic communication with the first chamber for allowing a liquid flow into the first chamber through the first one-way valve and restricting a liquid flow out of the first chamber through the first one-way valve. The first volume of liquid is aspirated with the first aspirator by moving the first piston. The method also includes aspirating a second volume of liquid with the first aspirator using an aspirator pump in fluidic communication with the first chamber to move liquid from the first chamber. The second volume is distinct from the first volume.

### BRIEF DESCRIPTION OF THE DRAWINGS

For a better understanding of the aforementioned embodiments as well as additional embodiments, reference should be made to the Description of Embodiments below, in conjunction with the following drawings in which like reference numerals refer to corresponding parts throughout the figures.

FIG. 1 is a perspective view of a plate in accordance with some embodiments.

FIG. 2 is a cross-sectional view of the plate shown in FIG. 1.

FIGS. 3A-31 are examples of wells of a plate in accordance with some embodiments.

FIGS. 4A-4D illustrate operations of a washer apparatus in accordance with some embodiments.

FIG. 5A is a schematic diagram illustrating a dispensing rate as a function of a height of a tip of a dispenser nozzle in accordance with some embodiments.

FIG. 5B is a schematic diagram illustrating an aspiration rate as a function of a height of a tip of an aspirator nozzle in accordance with some embodiments.

FIG. 5C is a schematic diagram illustrating a lateral position of a tip of an aspirator nozzle as a function of a height of the tip of the aspirator nozzle in accordance with some embodiments.

FIGS. 6A-6C illustrate operations of an aspirator actuator in accordance with some embodiments.

FIG. 7 illustrate a washer apparatus in accordance with some embodiments.

FIGS. 8A-8D illustrate operations of a device inducing a unidirectional fluid flow in accordance with some embodiments.

FIG. 9 illustrates a device inducing a unidirectional fluid flow in accordance with some embodiments.

FIG. 10 illustrates a device inducing a unidirectional fluid flow with a piston in accordance with some embodiments.

FIG. 11 illustrates a device inducing a unidirectional fluid flow with a flexible membrane in accordance with some embodiments.

FIG. 12 illustrates a device inducing a unidirectional fluid flow with a pressure chamber in accordance with some embodiments.

FIG. 13 illustrates a device inducing a unidirectional fluid flow with a pressure chamber and a piston in accordance with some embodiments.

FIG. 14 illustrates a device inducing unidirectional fluid flows with multiple flexible chambers in a common pressure chamber in accordance with some embodiments.

FIG. 15 illustrates a device inducing a unidirectional fluid flow in accordance with some embodiments.

FIG. 16 illustrates an apparatus with a dispenser pump in accordance with some embodiments.

FIG. 17 illustrates an apparatus with an aspirator pump in accordance with some embodiments.

FIG. 18 illustrates an apparatus with an aspirator pump in accordance with some embodiments.

Like reference numerals refer to corresponding parts throughout the drawings.

Drawings are not necessarily drawn to scale unless indicated otherwise.

### DESCRIPTION OF EMBODIMENTS

Methods, devices, and apparatus for washing samples are described. Reference will be made to certain embodiments, examples of which are illustrated in the accompanying drawings. While the claims will be described in conjunction with the embodiments, it will be understood that it is not intended to limit the claims to these particular embodiments alone. On the contrary, the embodiments are intended to cover alternatives, modifications and equivalents that are within the spirit and scope of the appended claims.

Moreover, in the following description, numerous specific details are set forth to provide a thorough understanding of the embodiments. However, it will be apparent to one of ordinary skill in the art that the embodiments may be practiced without these particular details. In other instances, methods, procedures, components, and networks that are well-known to those of ordinary skill in the art are not described in detail to avoid obscuring aspects of the embodiments.

It will also be understood that, although the terms first, second, etc. may be used herein to describe various elements, these elements should not be limited by these terms. These terms are only used to distinguish one element from another. For example, a first valve could be termed a second valve, and, similarly, a second valve could be termed a first valve, without departing from the scope of the embodiments. The first valve and the second valve are both valves, but they are not the same valve.

The terminology used in the description of the embodiments herein is for the purpose of describing particular embodiments only and is not intended to be limiting of the invention. As used in the description of the embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

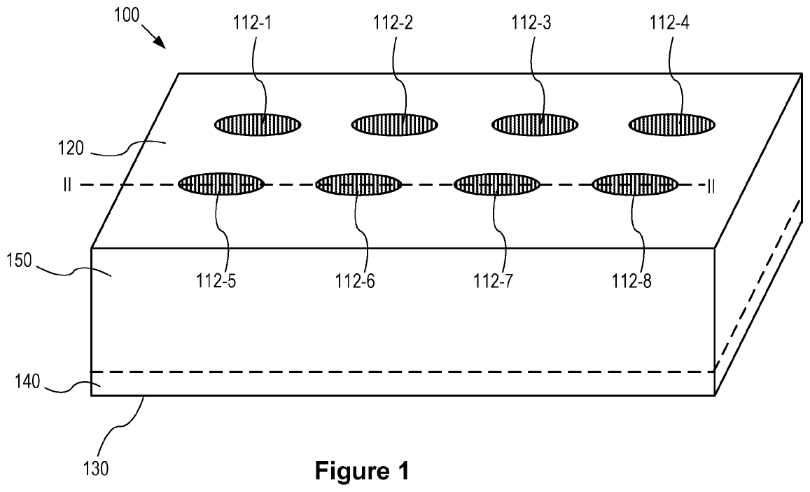

FIG. 1 is a perspective view of a plate 100 in accordance with some embodiments. The plate 100 has a top surface 120 and a bottom surface 130 opposite to the top surface 120. A plurality of wells 112 (e.g., wells 112-1 through 112-8) is defined in the plate 100. The plate 100 includes a first portion 140 that corresponds to a bottom of the plurality of wells 112 and a second portion 150 that corresponds to one or more walls of the plurality of wells 112. In some embodiments, the plate 100 is formed integrally. In some embodiments, the plate 100 is formed by attaching two or more portions together (e.g., by bonding separately formed first and second portions 140 and 150). In some embodiments, as shown in FIG. 1, the plurality of wells 112 is arranged in an array (e.g., 2-by-3 array, 2-by-4 array, 3-by-4 array, 4-by-6 array, 6-by-8 array, 8-by-12 array, 16-by-24 array, 32-by-48 array, etc.). In some embodiments, a respective well 112 is a cylindrical well (e.g., a cross-section of the respective well 112 along a plane substantially parallel to the plate 100 has a shape of a circle).

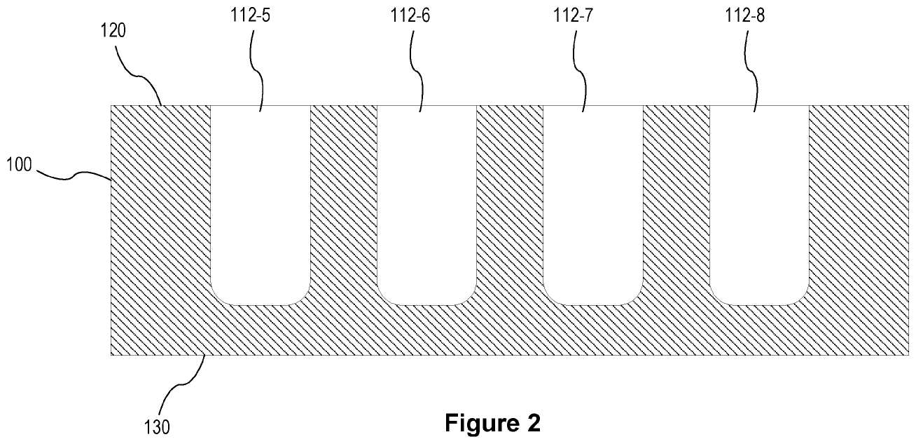

FIG. 2 is a cross-sectional view of the plate 100 shown in FIG. 1. In some embodiments, a respective well 112 has a width of 2 mm-170 mm (e.g., 2 mm, 3 mm, 4 mm, 5 mm, 6 mm, 7 mm, 8 mm, 9 mm, 10 mm, 15 mm, 20 mm, 25 mm, 30 mm, 35 mm, 40 mm, 45 mm, 50 mm, 55 mm, 60 mm, 65 mm, 70 mm, 75 mm, 80 mm, 85 mm, 90 mm, 95 mm, 100 mm, 110 mm, 120 mm, 130 mm, 140 mm, 150 mm, 160 mm, 170 mm, or any interval between two of the aforementioned values, such as 5 mm-8 mm). In some embodiments, the respective well 112 has a height of 2 mm-170 mm (e.g., 2 mm, 3 mm, 4 mm, 5 mm, 6 mm, 7 mm, 8 mm, 9 mm, 10 mm, 15 mm, 20 mm, 25 mm, 30 mm, 35 mm, 40 mm, 45 mm, 50 mm, 55 mm, 60 mm, 65 mm, 70 mm, 75 mm, 80 mm, 85 mm, 90 mm, 95 mm, 100 mm, 110 mm, 120 mm, 130 mm, 140 mm, 150 mm, 160 mm, 170 mm, or any interval between two of the aforementioned values, such as 3 mm-70 mm).

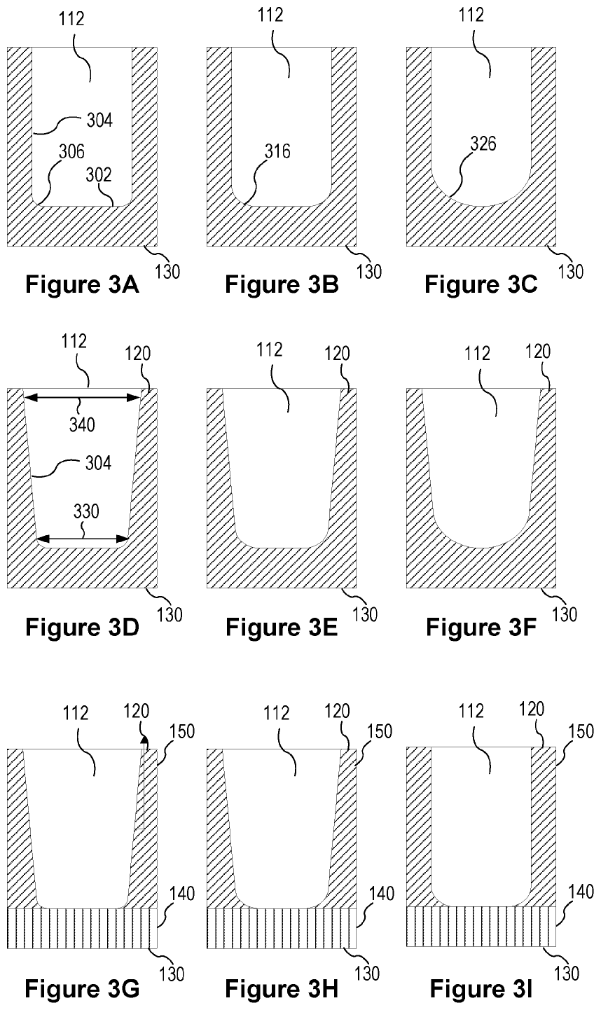

FIGS. 3A-31 are examples of wells 112 of a plate in accordance with some embodiments. FIGS. 3A-3C illustrate wells 112 having round corners (e.g., round corner 306, 316, or 326) between a bottom surface 302 and a wall 304. In some embodiments, the round corners have different radii (e.g., the round corner 306 has a radius that is smaller than the radius of the round corner 316). In some embodiments, the bottom surface 302 (or at least a portion of the bottom surface 302) is substantially flat (e.g., the bottom surface 302 is flat), as shown in FIGS. 3A and 3B. In some embodiments, the bottom surface 302 does not have any flat portion.

In some embodiments, the wall 304 is substantially perpendicular to the bottom surface 302 (e.g., the wall 304 is perpendicular to the bottom surface 302 as shown in FIGS. 3A and 3B). In some embodiments, the wall 304 shown in the cross section of the plate 100 is substantially perpendicular to a plane substantially parallel to the plate 100 (e.g., a plane that is parallel to the bottom surface 130). In some embodiments, the well 112 has substantially the same cross section (e.g., taken along a plane parallel to the plate 100) along the height of the well 112. For example, the well 112 has a cylindrical shape.

In some embodiments, wells 112 have slanted side walls, as shown in FIGS. 3D-3F. In FIGS. 3D-3F, the wall 304 shown in FIGS. 3D-3F is non-perpendicular to a plane substantially parallel to the plate 100 (e.g., a plane that is parallel to the bottom surface 130). In some embodiments, the well 112 has a first cross section (e.g., characterized by a width 340) adjacent to a top of the well 112 and a second cross section (e.g., characterized by a width 330) adjacent to a bottom of the well 112, where the second cross section is different from the first cross section. For example, the width 340 is different from the width 330 (e.g., the width 340 is greater than the width 330). In FIGS. 3D-3F, the wells 112 also have round corners between the bottom surface and the wall.

In some embodiments, at least a portion (e.g., the first portion 140) of the plate is made of a substantially transparent material (e.g., glass). In some embodiments, the substantially transparent material is substantially transparent (e.g., having a transmittance of at least 50%, 60%, 70%, 80%, 90%, 95%, or 99%, or within a range between any two of the aforementioned values). In some embodiments, the substantially transparent material is substantially transparent to visible light. In some embodiments, the substantially transparent material is substantially transparent to infrared light. In some embodiments, the substantially transparent material is substantially transparent to ultraviolet light. In some embodiments, at least a portion (e.g., the second portion 150) of the plate is made of a substantially opaque material.

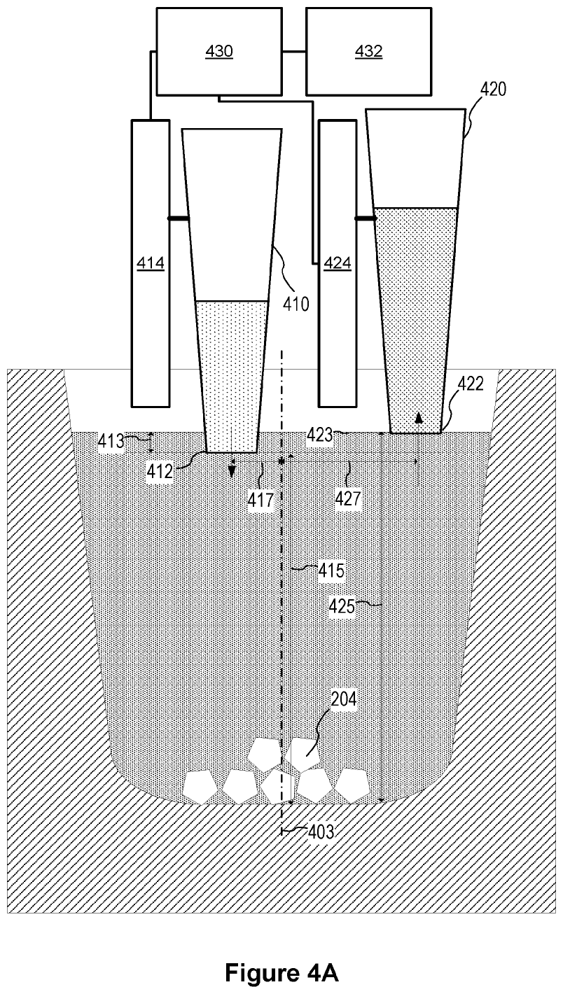

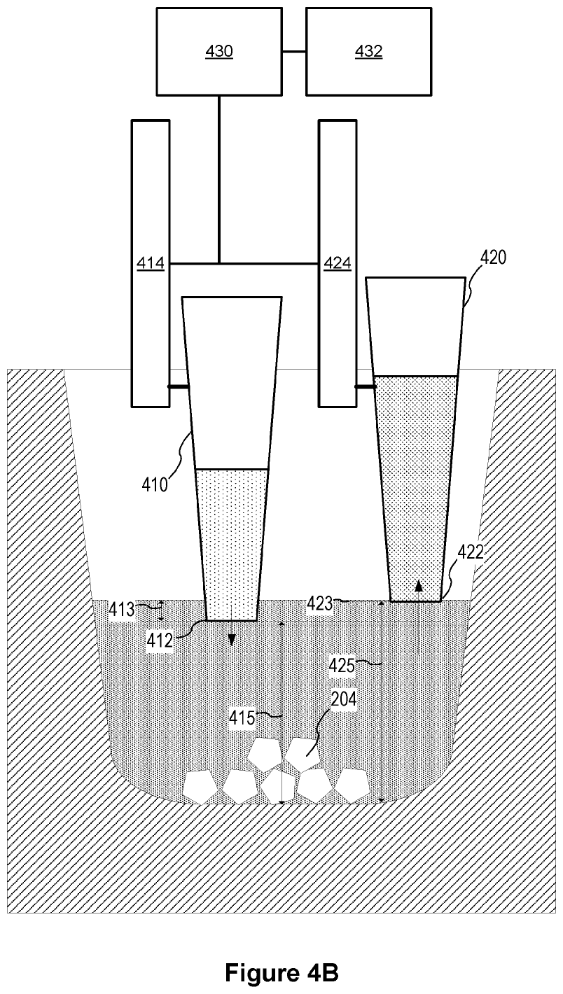

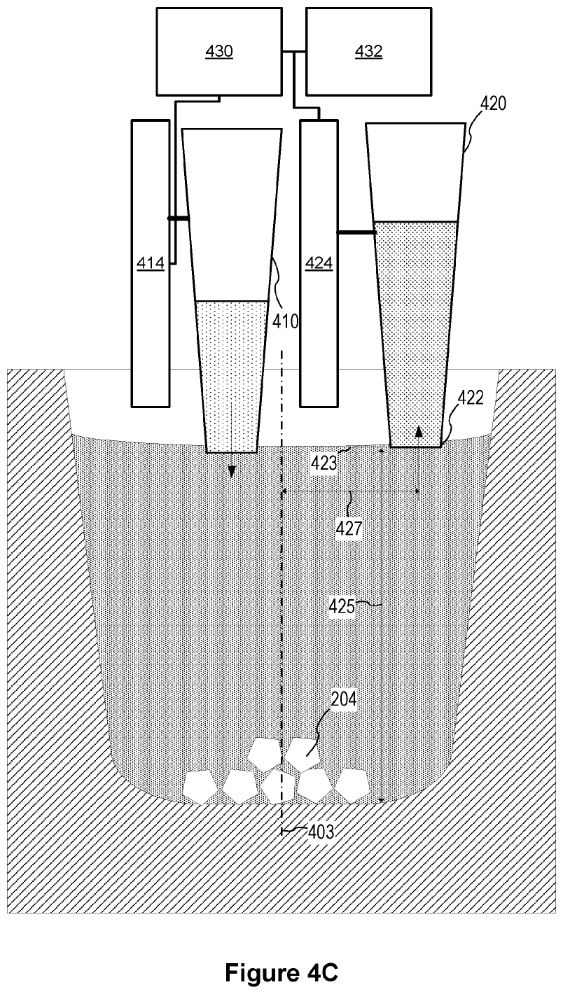

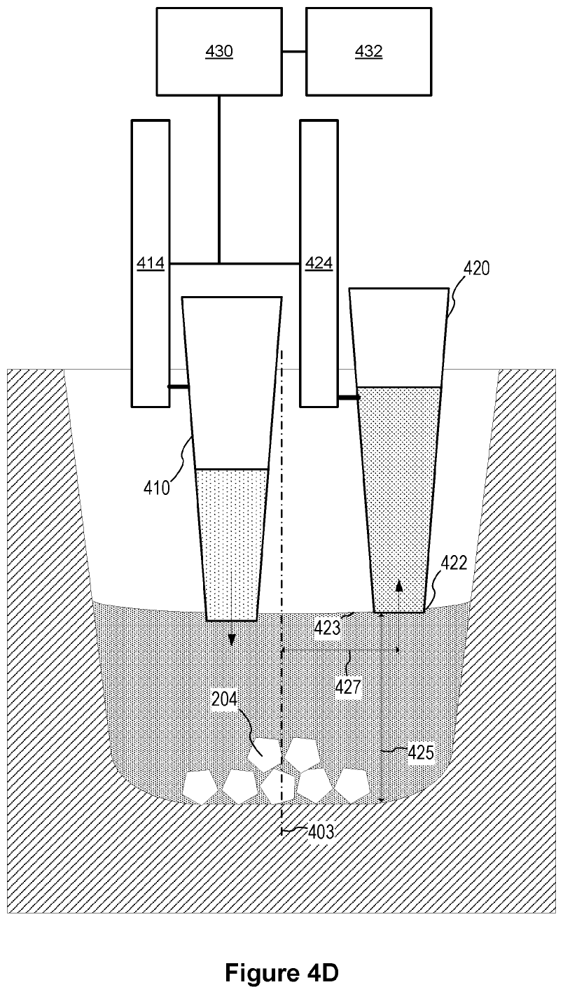

FIGS. 4A-4D illustrate operations of a washer apparatus in accordance with some embodiments. The washer apparatus shown in FIG. 4A includes a dispenser with a dispenser nozzle 410 for dispensing a wash liquid to a sample liquid containing a sample 204 (e.g., one or more particles or one or more cells). In FIG. 4A, certain parts of the dispenser (e.g., a piston and a cylinder) are not shown so as not to obscure other aspects of the dispenser. The washer apparatus also includes a dispenser actuator 414 coupled with the dispenser nozzle 410 (e.g., for changing a position of the dispenser nozzle 410).

The washer apparatus includes one or more processors 430 and memory 432 storing instructions for execution by the one or more processors 430. In some embodiments, the stored instructions include instructions for sending one or more signals to the dispenser actuator 414 for placing a tip 412 of the dispenser nozzle 410 in contact with the sample liquid at a location adjacent to a top liquid surface (e.g., meniscus) of the sample liquid for dispensing the wash liquid through the dispenser nozzle. In FIG. 4A, a tip 412 of the dispenser nozzle 410 is at a distance 413 from a top surface of the liquid (e.g., the meniscus of the sample liquid or a mixture of the sample liquid and the wash liquid) and at a distance 415 from the bottom of the well. FIG. 4A also shows that the tip 412 of the dispenser nozzle 410 is at a distance 417 from a central axis 403 of the well (e.g., a distance from the central axis 403 to a central axis of the dispenser nozzle 410).

In FIG. 4A, the washer apparatus further includes an aspirator with an aspirator nozzle 420 for aspirating liquid (e.g., from the sample liquid or a mixture of the sample liquid and the wash liquid), and an aspirator actuator 424 coupled with the aspirator nozzle 420 (e.g., for changing a position of the aspirator nozzle 420). In FIG. 4A, a tip 422 of the aspirator nozzle 420 is at a distance 423 from the top surface of the liquid and a distance 425 from the bottom of the well. FIG. 4A also shows that the tip 422 of the aspirator nozzle 420 is at a distance 427 from the central axis 403 of the well. In some embodiments, the distance 423 is zero (e.g., when the aspirator sets the height of the sample liquid by aspiration).

In some embodiments, the washer apparatus moves the aspirator nozzle 420 (e.g., using the aspirator actuator 424) independently from moving the dispenser nozzle 410 (e.g., using the dispenser actuator 414). For example, the aspirator nozzle 420 may move up or down independently from the up or down movement of the dispenser nozzle 410. In some embodiments, the aspirator nozzle 420 may be moved out of contact with the liquid while the aspirator nozzle 420 is in contact with the liquid (e.g., the aspirator nozzle 420 is moved away from the liquid while the dispenser nozzle 410 is in contact with the liquid to dispense a wash liquid), In some embodiments, the washer apparatus includes a single actuator for moving both the aspirator nozzle 420 and the dispenser nozzle 410. In some embodiments, the aspirator nozzle 420 is positioned at a fixed location relative to the dispenser nozzle 410 so that the aspirator nozzle 420 and the dispenser nozzle 410 move together.

In some embodiments, the height 425 of the tip 422 of the aspirator nozzle 420 is substantially the same as the height 415 of the tip 412 of the dispenser nozzle 410. In some embodiments, the height 425 of the tip 422 of the aspirator nozzle 420 is greater than the height 415 of the tip 412 of the dispenser nozzle 410.

In some embodiments, the dispenser forgoes dispensing the wash liquid while the aspirator aspirates the sample liquid (or a mixture of the sample liquid and the wash liquid). In some embodiments, the aspirator forgoes aspirating the sample liquid (or a mixture of the sample liquid and the wash liquid) while the dispenser dispenses the wash liquid.

In some embodiments, the dispenser dispenses the wash liquid at a first dispensing rate and the aspirator aspirates the sample liquid (or a mixture of the sample liquid and the wash liquid) concurrently at a first aspiration rate. When the first dispensing rate matches the first aspiration rate, the height of the top surface of the sample liquid (or the mixture of the sample liquid and the wash liquid) remains unchanged. When the first dispensing rate is less than the first aspiration rate (e.g., including when the dispenser forgoes dispensing while the aspirator aspirates), the height of the top surface of the sample liquid decreases. When the first dispensing rate is greater than the first aspiration rate (e.g., including when the aspirator forgoes aspiration while the dispenser dispenses), the height of the top surface of the sample liquid increases.

In some embodiments, the washer apparatus dispenses the wash liquid to the sample liquid and subsequently aspirates a mixture of the sample liquid and the wash liquid. In some embodiments, the washer apparatus aspirates the sample liquid (or a mixture of the sample liquid and the wash liquid) and subsequently dispenses the wash liquid.

In some embodiments, the washer apparatus aspirates a portion of the sample liquid (e.g., until the remaining sample liquid corresponds to, or less than, a predefined volume) followed by concurrently dispensing the wash liquid while aspirating the sample liquid (or a mixture of the sample liquid and the wash liquid). In some embodiments, the tip 412 of the dispenser nozzle 410 remains adjacent to the top liquid surface during the aspiration of the sample liquid (e.g., the tip 412 of the dispenser nozzle 410 moves downward during the aspiration of the sample liquid). In some embodiments, the tip 422 of the aspirator nozzle 420 also remains adjacent to the top liquid surface during the aspiration of the sample liquid. In some embodiments, the wash liquid is dispensed at a rate that corresponds to a rate of aspirating the sample liquid (or a mixture of the sample liquid and the wash liquid). The aspiration of the sample liquid prior to concurrent dispensing of the wash liquid and aspiration of the sample liquid reduces the volume of the remaining sample liquid, which increases the efficiency of washing. In some embodiments, the tip 412 of the dispenser nozzle 410 remains adjacent to the top liquid surface during concurrent dispensing of the wash liquid and aspiration of the sample liquid (e.g., the tip 412 of the dispenser nozzle 410 moves downward during the concurrent dispensing of the wash liquid and aspiration of the sample liquid). In some embodiments, the tip 422 of the aspirator nozzle 420 also remains adjacent to the top liquid surface during the concurrent dispensing of the wash liquid and aspiration of the sample liquid. In some embodiments, subsequent to concurrent dispensing of the wash liquid and aspiration of the sample liquid, the wash apparatus dispenses a liquid (e.g., buffer) to the remaining sample liquid (or a mixture of the remaining sample liquid and the wash liquid). In some embodiments, the combination of the dispensed liquid and the remaining sample liquid (or a mixture of the remaining sample liquid and the wash liquid) has a volume that corresponds to a volume of the sample liquid prior to aspiration of the sample liquid. In some embodiments, the tip 422 of the aspirator nozzle 420 remains adjacent to the top liquid surface during dispensing of the liquid. In some embodiments, the tip 412 of the dispenser nozzle 410 remains adjacent to the top liquid surface during dispensing of the liquid.

FIG. 4B shows that the aspirator aspirates at an aspiration rate greater than a dispensing rate of the dispenser (e.g., the aspirator aspirates while the dispenser forgoes dispensing), and as a result, the height of the top surface of the sample liquid (or a mixture of the sample liquid and the wash liquid) has decreased. FIG. 4B also shows that the aspirator nozzle 420 has moved down (e.g., by using the aspirator actuator 424) along with the decrease in the height of the sample liquid (or the mixture of the sample liquid and the wash liquid) so that the tip 422 of the aspirator nozzle 420 remains adjacent to the top surface of the sample liquid (or the mixture of the sample liquid and the wash liquid). For example, in some cases, the distance 423 remains constant.

In some embodiments, as shown in FIG. 4B, the dispenser nozzle 410 also moves down (e.g., using the dispenser actuator 414) in conjunction with the downward movement of the aspirator nozzle 420. This allows the tip 412 of the dispenser nozzle 410 remains adjacent to the top surface of the sample liquid (or the mixture of the sample liquid and the wash liquid). For example, in some cases, the distance 413 remains constant.

FIG. 4C is similar to FIG. 4A except that the top surface of the sample liquid (or a mixture of the sample liquid and the wash liquid) has a curve (e.g., a meniscus) due to surface tension. In FIG. 4D, which is similar to FIG. 4B, the top surface of the sample liquid (or a mixture of the sample liquid and the wash liquid) also has a curve (e.g., a meniscus) due to surface tension. FIG. 4D also shows that as the aspirator nozzle 420 moves downward, the aspirator nozzle 420 also moves laterally (e.g., using the aspirator actuator 424). For example, the aspirator nozzle 420 may move laterally toward the central axis of the well so that the tip 422 of the aspirator nozzle 420 moves away from a peripheral region of the sample liquid (or a mixture of the sample liquid and the wash liquid) having a steep curve as the tip 422 of the aspirator nozzle 420 moves closer to the bottom of the well. In some configurations, the aspirator nozzle 420 moves along a curve (e.g., a combination of a downward movement and a lateral movement).

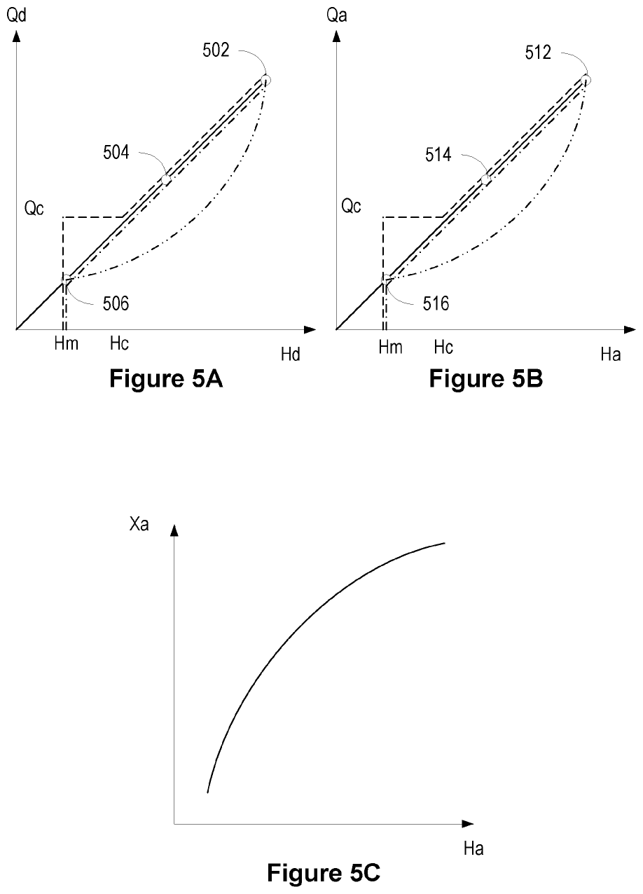

FIG. 5A is a schematic diagram illustrating a dispensing rate Qd as a function of a height Hd of the tip 412 of a dispenser nozzle 410 in accordance with some embodiments. In some embodiments, the dispensing rate Qd decreases linearly with the decreasing height Hd of the tip 412 of the dispenser nozzle 410 (as indicated by the solid line in FIG. 5A). In some embodiments, the dispensing rate Qd decreases linearly with the decreasing height Hd of the tip 412 of the dispenser nozzle 410 for a range of the height Hd but drops to zero at a minimum dispensing height Hm (as indicated by the dot-dash line in FIG. 5A). This avoids dispensing the wash liquid too close to the bottom of the well where the samples are located, thereby avoiding or reducing disruption of the samples located at the bottom of the well. In some embodiments, the dispensing rate Qd decreases linearly with the decreasing height Hd of the tip 412 of the dispenser nozzle 410 for a range of the height Hd but the dispensing rate Qd remains constant at Qc between a height Hc of the tip 412 of the dispenser nozzle 410 and the height Hm, and the dispensing rate Qd drops to zero below the minimum dispensing height Hm (as illustrated by a dashed line in FIG. 5A). In some embodiments, the dispensing rate Qd decreases nonlinearly with the decreasing height Hd of the tip 412 of the dispenser nozzle 410 (as illustrated by a curved double-dot dash line in FIG. 5A). In some embodiments, the point 502 corresponds to a high dispensing rate at a high height, the point 504 corresponds to a medium dispensing rate (less than the high dispensing rate) at a medium height (less than the high height), and the point 506 corresponds to a low dispensing rate (less than the medium dispensing rate) at a low height (less than the medium height).

FIG. 5B is a schematic diagram illustrating an aspiration rate Qa as a function of a height Ha of the tip 422 of an aspirator nozzle 420 in accordance with some embodiments. In some embodiments, the aspiration rate Qa changes along one of the illustrated lines, which correspond to the lines described with respect to FIG. 5A. For brevity, such details are not repeated herein. In some embodiments, the point 512 corresponds to a high aspiration rate at a high height, the point 514 corresponds to a medium aspiration rate (less than the high aspiration rate) at a medium height (less than the high height), and the point 516 corresponds to a low aspiration rate (less than the medium aspiration rate) at a low height (less than the medium height).

FIG. 5C is a schematic diagram illustrating a lateral position of a tip 422 of an aspirator nozzle 420 as a function of a height of the tip of the aspirator nozzle in accordance with some embodiments. In some embodiments, as shown in FIG. 5C, the tip 422 of the aspirator nozzle 420 moves laterally (so that Xa corresponding to the distance 427 changes) as the height Ha of the tip 422 of the aspirator nozzle 420 changes (e.g., downward), as described with respect to FIGS. 4C and 4D.

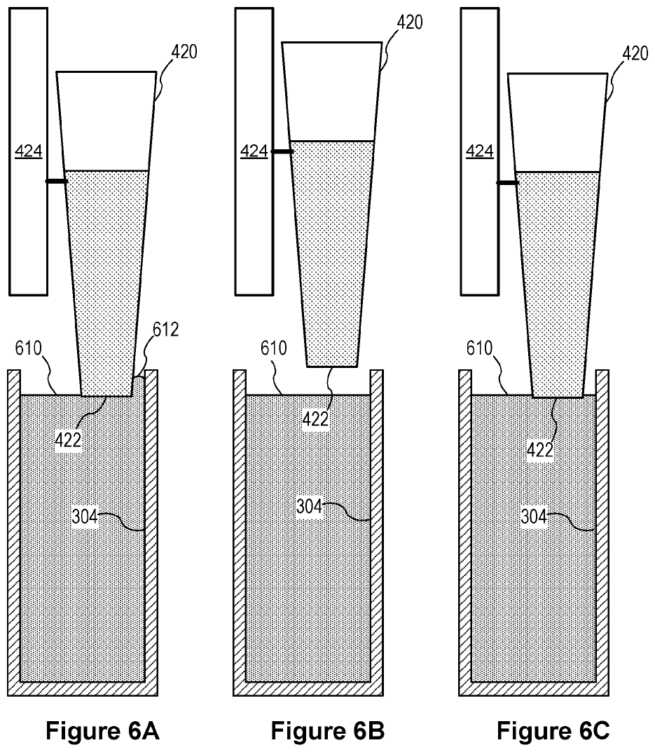

FIGS. 6A-6C illustrate operations of an aspirator actuator (called “pecking”) in accordance with some embodiments. FIG. 6A shows that when the tip 422 of the aspirator nozzle 420 is immersed in the liquid 610 (e.g., the sample liquid or a mixture of the sample liquid and the wash liquid), a portion 612 of the liquid 610 is trapped between the aspirator nozzle 420 and a wall 304 (e.g., due to surface tension). This portion 612 of the liquid 610 does not mix well with the remainder of the liquid 610, which, in turn, reduces the washing efficiency.

FIG. 6B shows that the aspirator nozzle 420 is lifted so that the tip 422 of the aspirator nozzle 420 is no longer in contact with the liquid 610. This also eliminates or reduces a portion of the liquid 610 trapped between the aspirator nozzle 420 and the wall 304.

FIG. 6C shows that the aspirator nozzle 420 is moved down (e.g., while the aspirator nozzle 420 is aspirating) so that the tip 422 of the aspirator nozzle 420 is again in contact with the liquid 610. FIG. 6C also shows that at this moment, there is no or little portion of the liquid 610 that is trapped between the aspirator nozzle 420 and the wall 304. This facilitates a more uniform distribution of analytes within the liquid 610 during washing, which improves the washing efficiency.

In addition, even when there is no wicking of the portion 612 of the liquid 610 between the aspirator nozzle 420 and the wall 304, the aspirator nozzle 420 may reduce diffusion of analytes in the volume between the aspirator nozzle 420 and the wall 304 to the remainder of the liquid 610, which reduces the washing efficiency. Lifting the tip 422 of the aspirator nozzle 420 off the liquid 610 allows, and in some cases, facilitates, distribution of the analytes in the volume between the aspirator nozzle 420 and the wall 304 to the remainder of the liquid 610, thereby improving the washing efficiency.

FIG. 7 illustrate a washer apparatus in accordance with some embodiments. The washer apparatus shown in FIG. 7 is similar to the washer apparatus shown in FIGS. 4A and 4B except that the dispenser nozzle 410 is tilted (e.g., angled) so that the tip 412 of the dispenser nozzle 410 is closer to the wall than the top of the dispenser nozzle 410. In some embodiments, the angle of the dispenser nozzle 410 changes as a function of the height of the tip 412 of the dispenser nozzle 410 (e.g., the dispenser nozzle 410 may be oriented vertically at a high height and the dispenser nozzle 410 begins to turn as the height of the tip 412 of the dispenser nozzle 410 decreases).

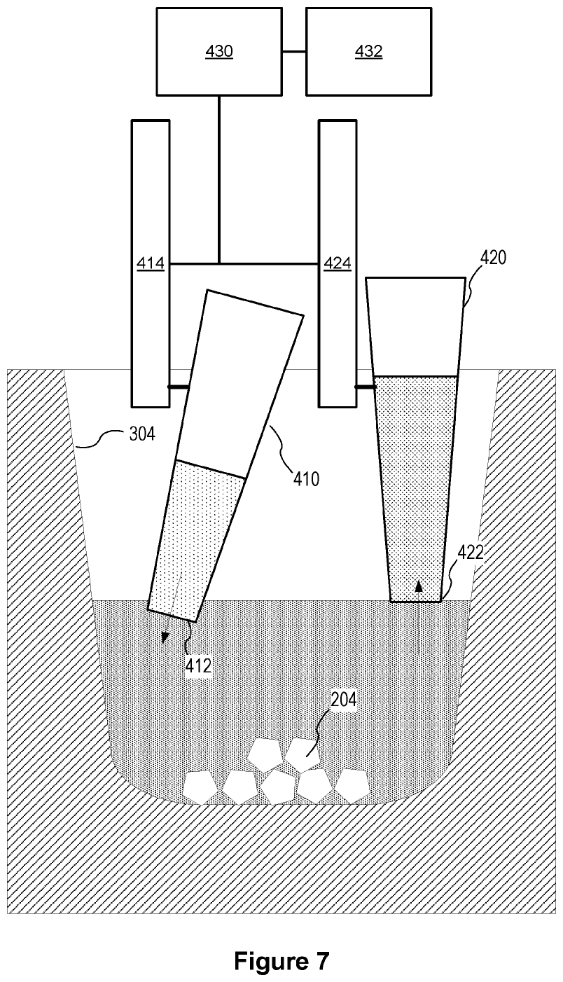

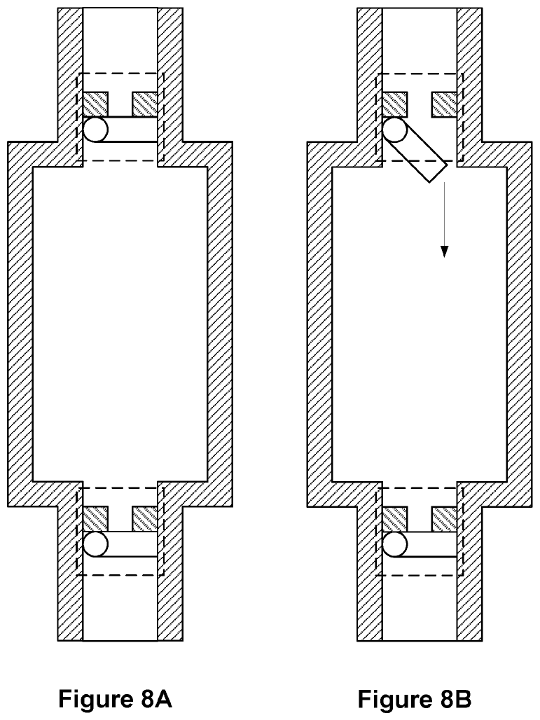

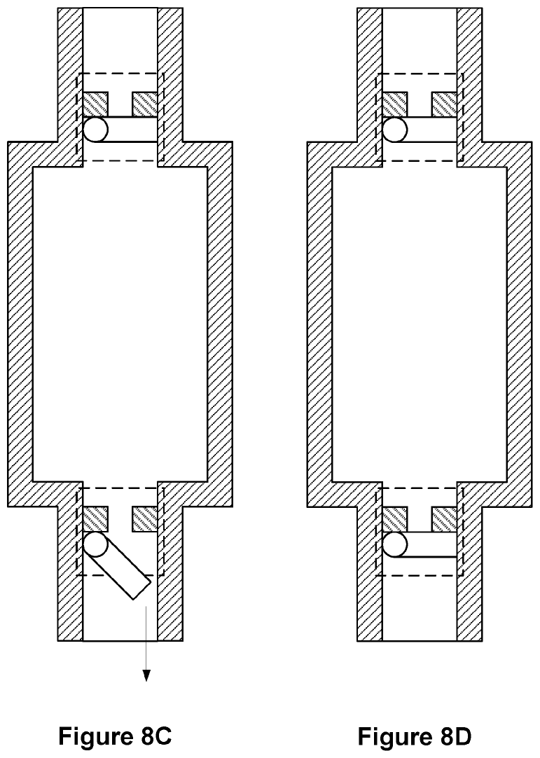

FIGS. 8A-8D illustrate operations of a device inducing a unidirectional fluid flow in accordance with some embodiments. In FIGS. 8A-8D, the device includes two one-way valves (also called check valves). The configuration of the one-way valve shown in FIGS. 8A-8D is only an example, and there are many other configurations of a one-way valve. For brevity, such details are not repeated herein.

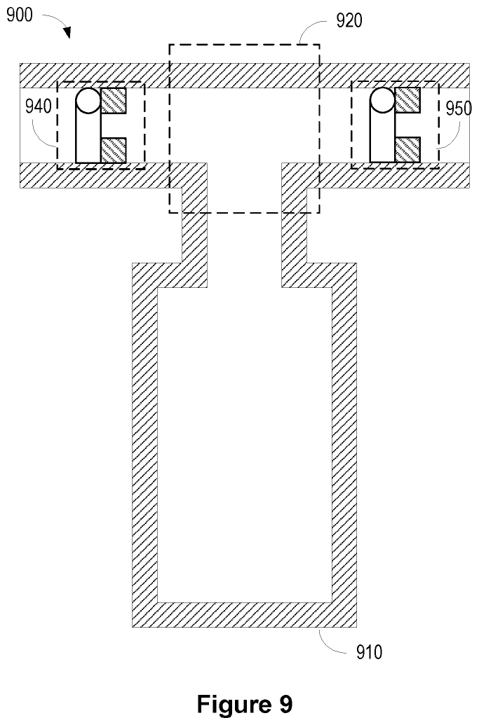

FIG. 9 illustrates a device 900 inducing a unidirectional fluid flow in accordance with some embodiments. The device 900 shown in FIG. 9 includes a chamber 910 with a multi-channel connector 920. The multi-channel connector 920 is coupled to the chamber 910, a one-way valve 940 and a one-way valve 950 at respective ports of the multi-channel connector 920.

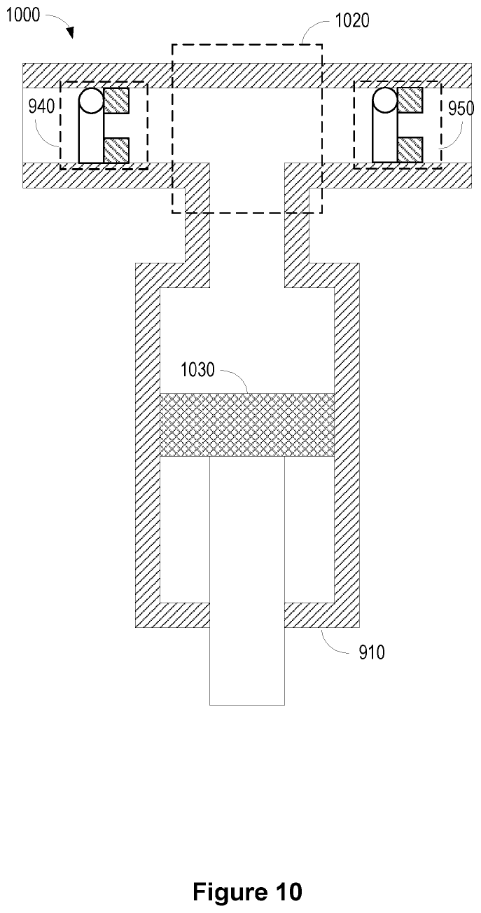

FIG. 10 illustrates a device 1000 inducing a unidirectional fluid flow with a piston 1030 in accordance with some embodiments. The device 1000 is similar to the device 900, except that the device 1000 includes a piston 1030 (also called plunger) within the chamber 910. The piston 1030 can change the pressure within the chamber 910 so that liquid can flow into the chamber 910 through the one-way valve 950 and liquid can flow out from the chamber 910 through the one-way valve 940.

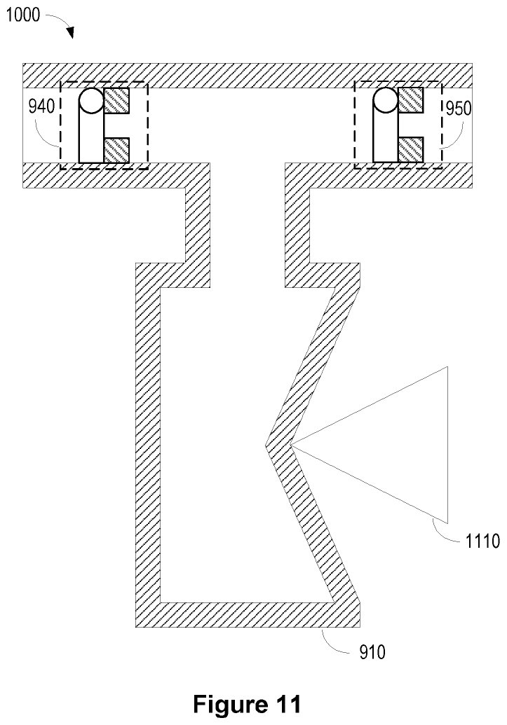

FIG. 11 illustrates a device 1100 inducing a unidirectional fluid flow with a flexible membrane in accordance with some embodiments. The device 1100 is similar to the device 900, except that at least a portion of the chamber 910 is made of a flexible material so that a mechanical component 1110 (e.g., a screw, a clamp, a push rod, etc.) can cause deformation of the chamber 910 (or the portion of the chamber 910 made of a flexible material), which, in turn, causes liquid in the chamber 910 to flow out through the one-way valve 940. In some embodiments, the mechanical component 1110 can also cause restoration of the chamber 910 (or the portion of the chamber 910 made of a flexible material), which, in turn, causes liquid to flow into the chamber 910 through the one-way valve 950.

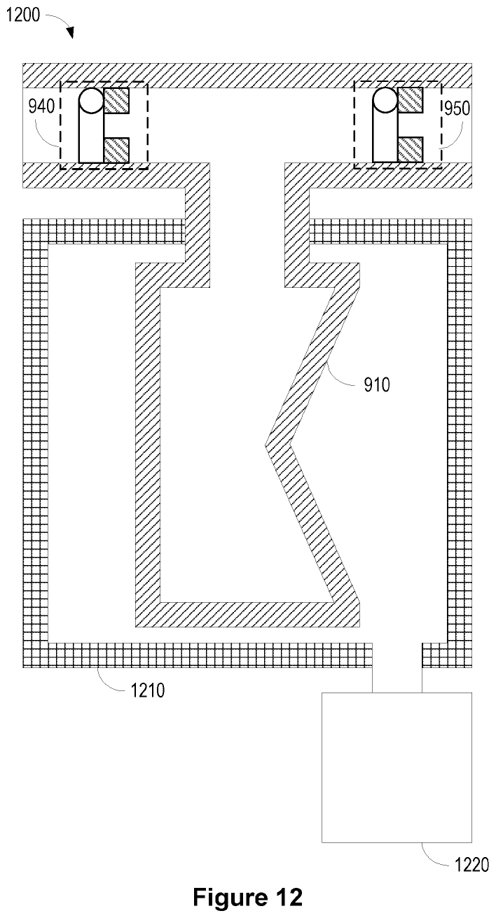

FIG. 12 illustrates a device 1200 inducing a unidirectional fluid flow with a pressure chamber 1210 in accordance with some embodiments. The device 1200 is similar to the device 1100, except that the device 1200 includes a second chamber 1210 instead of the mechanical component 1110. In FIG. 12, at least a portion of the chamber 910 is positioned inside the second chamber 1210 so that a change in pressure inside the second chamber 1210 (e.g., caused by an external pressure source 1220, such as a pump) causes deformation of the chamber 910 (or the portion of the chamber 910 made of a flexible material), which, in turn, causes liquid in the chamber 910 to flow out through the one-way valve 940. In some embodiments, the pressure inside the second chamber 1210 can also cause restoration of the chamber 910 (or the portion of the chamber 910 made of a flexible material), which, in turn, causes liquid to flow into the chamber 910 through the one-way valve 950.

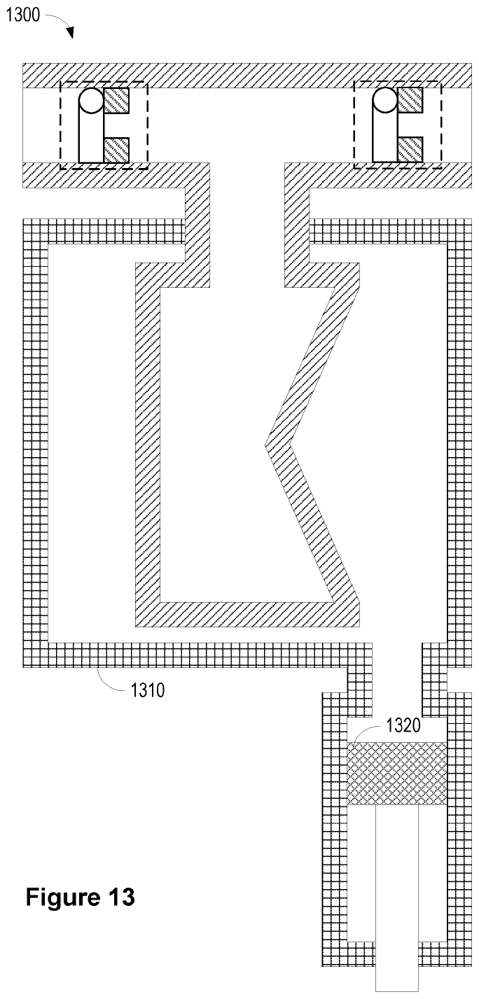

FIG. 13 illustrates a device 1300 inducing a unidirectional fluid flow with a pressure chamber 1310 and a piston in accordance with some embodiments. The device 1300 is similar to the device 1210 except that the second chamber 1310 is coupled to a piston 1320 instead of a pump.

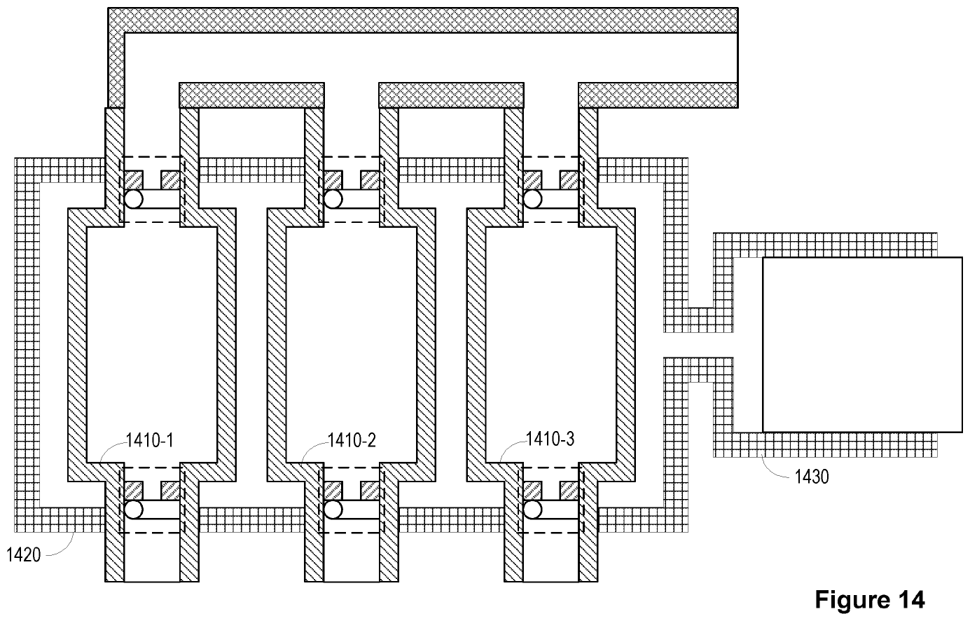

FIG. 14 illustrates a device inducing unidirectional fluid flows with multiple flexible chambers (e.g., chambers 1410-1 through 1410-3) in a common pressure chamber 1420 in accordance with some embodiments. The device shown in FIG. 14 is similar to the device 1300 except that multiple chambers (e.g., chambers 1410-1 through 1410-3), each coupled with one-way valves and having a portion made of a flexible material, are located in the second chamber 1420. Changing a pressure inside the second chamber 1420 causes deformation of the chambers 1410-1 through 1410-3 (or respective portions of the chambers 1410-1 through 1410-3 made of a flexible material), which, in turn, causes liquid in the chambers 1410-1 through 1410-3 to flow out (e.g., concurrently) from the respective chambers 1410-1 through 1410-3. In some embodiments, the pressure inside the second chamber 1420 can also cause restoration of the chambers 1410-1 through 1410-3 (or respective portions of the chambers 1410-1 through 1410-3 made of a flexible material), which, in turn, causes liquid to flow into the chambers 1410-1 through 1410-3. Although FIG. 14 shows a device dispensing liquid from a common source through respective chambers, a device aspirating liquid from respective chambers to a common drain can be configured by changing the directions of the one-way valves.

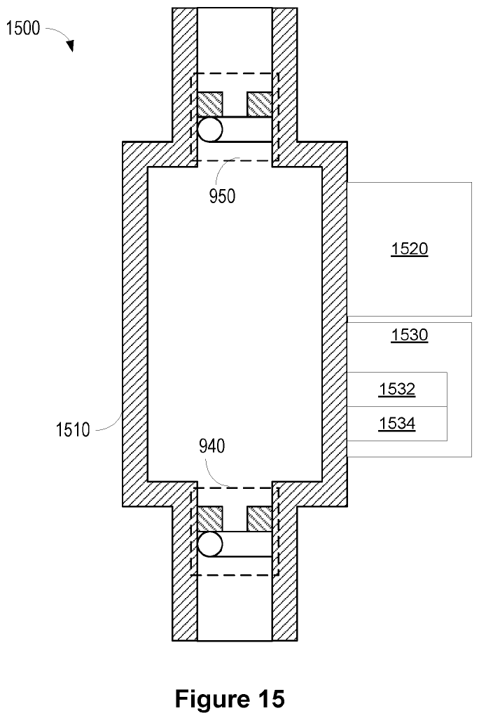

FIG. 15 illustrates a device 1500 inducing a unidirectional fluid flow in accordance with some embodiments. The device 1500 is similar to the device shown in FIGS. 8A-8D. In some embodiments, the device 1500 also includes an acoustic pressure generator 1520 (e.g., an ultrasonic generator). The acoustic pressure provided by the acoustic pressure generator 1520 causes small deformation of the chamber 1510 even if the chamber 1510 is made of a rigid material. In response to the acoustic pressure wave from the acoustic pressure generator 1520, the wall of the chamber 1510 vibrates, and liquid inside the chamber 1510 flows out of the chamber 1510 through the one-way valve 940. In addition, when the pressure inside the chamber 1510 decreases due to the outflow, external liquid may enter the chamber 1510 through the one-way valve 950. Although the volume of liquid dispensed by a single deformation may be small, because the frequency of the vibration can be high, the device 1500 can cause a unidirectional fluid flow with a substantial flow rate.

In some embodiments, the device 1500 includes a temperature controller 1530. In some embodiments, the temperature controller 1530 includes a heater 1532, a cooler 1534, or both. In some embodiments, the temperature controller 1530 changes the temperature of the chamber 1510. The chamber 1510 expands or contracts based on the change in the temperature, which causes the unidirectional fluid flow. In some embodiments, the temperature controller 1530 changes the temperature of the liquid inside the chamber 1510. The liquid inside the chamber 1510 expands or contracts based on the change in the temperature, which causes the unidirectional fluid flow.

In some embodiments, the device 1500 includes both the acoustic pressure generator 1520 and the temperature controller 1530. In some embodiments, the device 1500 includes only one of the acoustic pressure generator 1520 or the temperature controller 1530.

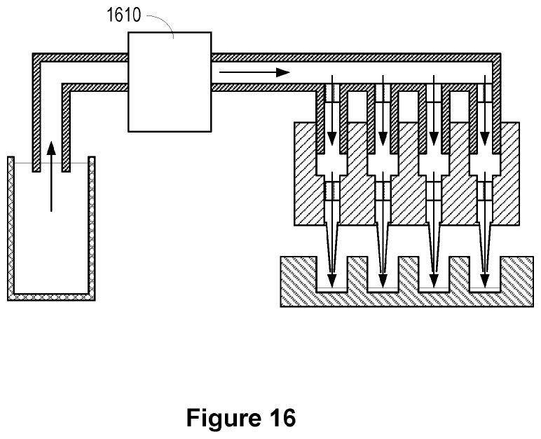

FIG. 16 illustrates an apparatus with a dispenser pump 1610 in accordance with some embodiments. The apparatus shown in FIG. 16 includes two or more dispensers (e.g., three dispensers), a respective dispenser having one or more one-way valves for dispensing liquid while restricting flow back of the liquid into the chamber of the respective dispenser. FIG. 16 also shows that the two or more dispensers are connected to the pump 1610. This configuration allows a precise volume to be dispensed from each dispenser (using the actuation mechanism of the dispenser) while a large volume, greater than the volume of a chamber in each dispenser, can be dispensed by using the dispenser pump 1610. This allows dispensing of a large volume of liquid (e.g., the wash liquid), which can increase the efficiency of washing.

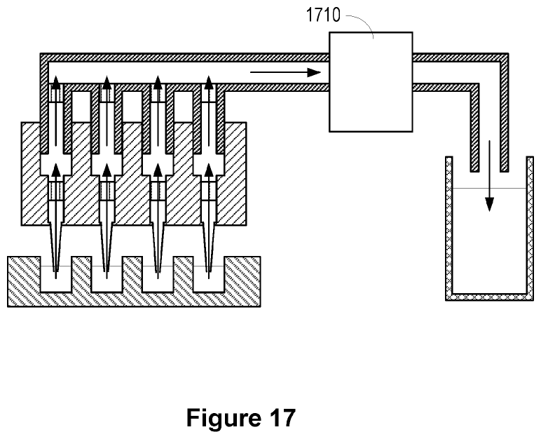

FIG. 17 illustrates an apparatus with an aspirator pump 1710 in accordance with some embodiments. The apparatus shown in FIG. 17 is similar to the apparatus shown in FIG. 16 except that the apparatus shown in FIG. 17 includes two or more aspirators instead of two or more dispensers shown in FIG. 16. The two or more aspirators are connected to the aspirator pump 1710. This configuration allows a precise volume to be aspirated by each aspirator (using the actuation mechanism of the aspirator) while a large volume, greater than the volume of a chamber in each aspirator, can be aspirated by using the aspirator pump 1710. This allows aspiration of a large volume of liquid, which can increase the efficiency of washing.

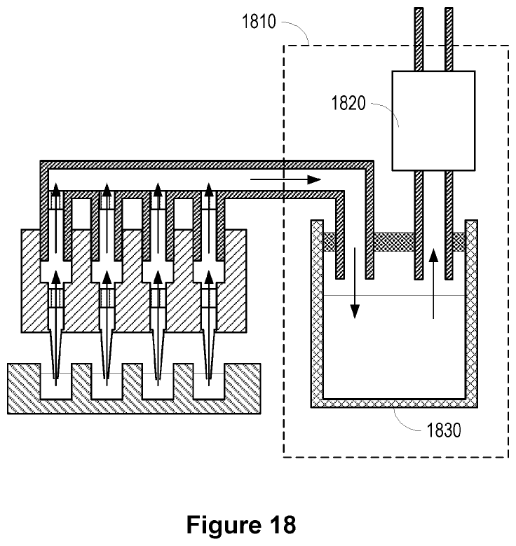

FIG. 18 illustrates an apparatus with an aspirator pump 1810 in accordance with some embodiments. The apparatus shown in FIG. 18 is similar to the apparatus shown in FIG. 17 except that the aspirator pump 1810 is a vacuum pump. The aspirator pump 1810 includes a pump 1820 and a reservoir 1830 so that the pump 1820 need not be in contact with the aspirated liquid.

### Experimental Results

### Experiment 1: Effect of Dispensing Conditions on Cell Retention

In some configurations for washing a sample containing cells or particles, it is important to avoid disruption of such cells or particles. One way to reduce the disruption of such cells or particles is to use a low dispensing rate. Another way to reduce the disruption of such cells or particles is to dispense the wash liquid at a location close to the top surface of the sample liquid (or a mixture of the sample liquid and the wash liquid) so that there is no dripping of the wash liquid onto the sample liquid (or the mixture of the sample liquid and the wash liquid), which causes disruption of the sample liquid (or the mixture of the sample liquid and the wash liquid).

The following table shows a result of an experiment, in which wells containing cells were washed under three different conditions.

| | Cell count | Cell count | |
|---|---|---|---|
| | before | after | |
| Sample | 3× wash | 3× wash | % Retention |
| MTP, 5 ul/s 3× wash | 45875 | 40297 | 87% |
| MTP, 5 ul/s 3× wash (Dripping) | 26875 | 13800 | 51% |
| MTP, 15 ul/s 3× wash | 38600 | 28000 | 76% |

The results obtained from the samples washed three times under different conditions show that the dispensing rate of 5 μL/s was better than the dispensing rate of 15 μL/s for retention of the cells. In addition, the results also show that dispensing the wash liquid without dripping had better cell retention than dispensing the wash liquid with dripping.

### Experiment 2: Effect of “Pecking” on Washing

In some configurations for washing, any dead volume (or dead corner) during aspiration reduces the efficiency of washing. For example, the dead volume between an aspirator nozzle and the side wall of a well close to the aspirator nozzle can reduce the efficiency of washing. Especially when the tip of the aspirator nozzle is positioned close to a wall of a well, liquid can cling on to both the tip of the aspirator nozzle and the wall, thereby creating the dead volume and/or increasing the volume of the residual liquid. One way to reduce the volume of the residual liquid is pecking, as described with respect to FIGS. 6A-6C.

The following table shows a result of an experiment, in which wells containing ink solutions were washed under four different conditions.

| | Dilution | Cumulative |
|---|---|---|
| Sample | Factor/wash | Dilution Factor |
| 4× wash (No Pecking) | 2.3 | 30 |
| 8× wash (No Pecking) | 1.77 | 100 |
| 4× wash (With Pecking) | 2.5 | 40 |
| 8× wash (With Pecking) | 2.5 | 1525 |

As shown above, the pecking operation improves the efficiency of washing so that after 8 washes, the washing efficiency has improved over 15 times (cumulative dilution factor of 1525 with pecking v. 100 without pecking). In addition, the pecking improves the consistency in washing as shown by the uniform dilution factor achieved with pecking.

In light of these principles and examples, we now turn to certain embodiments.

In accordance with some embodiments, an apparatus for washing a sample in a sample liquid in a well on a plate includes a dispenser with a dispenser nozzle for dispensing a wash liquid to the sample liquid: a dispenser actuator coupled with the dispenser nozzle: one or more processors: and memory storing instructions for execution by the one or more processors, the stored instructions including instructions for sending one or more signals to the dispenser actuator for placing a tip of the dispenser nozzle in contact with the sample liquid at a location adjacent to a top liquid surface (e.g., meniscus) of the sample liquid for dispensing the wash liquid through the dispenser nozzle.

In some embodiments, the stored instructions include instructions for sending one or more signals to the dispense actuator for placing the tip of the dispenser nozzle within a predefined distance (e.g., less than 0.1 mm, 0.2 mm, 0.3 mm, 0.4 mm, 0.5 mm, 0.6 mm, 0.7 mm, 0.8 mm, 0.9 mm, 1.0 mm, 1.1 mm, 1.2 mm, 1.3 mm, 1.4 mm, 1.5 mm, 1.6 mm, 1.7 mm, 1.8 mm, 1.9 mm, 2.0 mm, 2.1 mm, 2.2 mm, 2.3 mm, 2.4 mm, or 2.5 mm, or between any two of the aforementioned distances), below the top liquid surface of the sample liquid.

In some embodiments, a dispensing rate for dispensing the wash liquid through the dispenser nozzle is less than a predefined dispense rate (e.g., the predefined dispense rate is 1 μL/s, 2 μL/s, 3 L/s, 4 μL/s, 5 μL/s, 6 L/s, 7 μL/s, 8 μL/s, 9 L/s, 10 μL/s, 11 μL/s, 12 μL/s, 13 μL/s, 14 μL/s, 15 μL/s, 16 μL/s, 17 μL/s, 18 μL/s, 19 μL/s, 20 μL/s, 25 L/s, 30 μL/s, 35 μL/s, 40 μL/s, 45 μL/s, or 50 μL/s).

In some embodiments, the stored instructions include instructions for sending one or more signals to the dispenser for dispensing the wash liquid at different dispensing rates based on a height of the tip of the dispenser nozzle (e.g., from a bottom of the well). In some embodiments, the dispensing rate is reduced monotonically as the height of the tip of the dispenser nozzle decreases.

In some embodiments, the stored instructions include instructions for sending one or more signals to the dispenser for dispensing the wash liquid at a first dispensing rate at a first height of the tip of the dispenser nozzle and instructions for sending one or more signals to the dispenser for dispensing the wash liquid at a second dispensing rate distinct from the first dispensing rate at a second height of the tip of the dispenser nozzle that is distinct from the first height.

In some embodiments, the first height is greater than the second height and the first dispensing rate is greater than the second dispensing rate.

In some embodiments, the stored instructions also include instructions for sending one or more signals to the dispenser for dispensing the wash liquid at a third dispensing rate distinct from the first dispensing rate and the second dispensing rate at a third height of the tip of the dispenser nozzle distinct from the first height and the second height.

In some embodiments, the second height is greater than the third height and the second dispensing rate is greater than the third dispensing rate.

In some embodiments, the dispenser nozzle is positioned to be adjacent to a lateral center of the well (e.g., within 0.1 mm, 0.2 mm, 0.3 mm, 0.4 mm, 0.5 mm, 0.6 mm, 0.7 mm, 0.8 mm, 0.9 mm, 1.0 mm, 1.1 mm, 1.2 mm, 1.3 mm, 1.4 mm, 1.5 mm, 1.6 mm, 1.7 mm, 1.8 mm, 1.9 mm, 2 mm, 3 mm, 4 mm, 5 mm, 6 mm, 7 mm, 8 mm, 9 mm, 10 mm, or within 5%, 10%, 15%, 20%, or 25% of the diameter of the well from the lateral center of the well).

In some embodiments, the tip of the dispenser nozzle is angled toward a wall of the well.

In some embodiments, the apparatus also includes an aspirator with an aspirator nozzle for aspirating a liquid from the sample liquid.

In some embodiments, the apparatus also includes an aspirator actuator coupled with the aspirator nozzle. The stored instructions include instructions for sending one or more signals to the aspirator actuator for placing a tip of the aspirator nozzle.

In some embodiments, the stored instructions include instructions for sending one or more signals to the aspirator actuator for: lowering the aspirator nozzle so that the aspirator nozzle is in contact with the sample solution while the aspirator is aspirating the liquid from the sample solution: subsequent to lowering the aspirator nozzle, lifting the aspirator nozzle so that the aspirator nozzle ceases to be in contact with a top surface of the sample solution: and, subsequent to lifting the aspirator nozzle, lowering the aspirator nozzle so that the aspirator nozzle is in contact with the sample solution while the aspirator is aspirating the liquid from the sample solution.

In some embodiments, the stored instructions include instructions for sending one or more signals to the aspirator actuator for repeating the lifting operation and the lowering operation (e.g., until the remaining solution has a predefined height).

In some embodiments, the stored instructions include instructions for sending one or more signals to the aspirator actuator for placing the aspirator nozzle within a predefined distance from the top surface of the sample (e.g., the predefined distance is 100 μm, 200 μm, 300 μm, 400 μm, 500 μm, 600 μm, 700 μm, 800 μm, 900 μm, or 1000 μm).

In some embodiments, the aspirator nozzle is positioned relative to the dispenser nozzle so that a height of the aspirator nozzle (e.g., from a bottom of the well) is greater than a height of the dispenser nozzle (e.g., from the bottom of the well).

In some embodiments, the aspirator nozzle is positioned relative to the dispenser nozzle so that a height of the aspirator nozzle (e.g., from a bottom of the well) is substantially the same as a height of the dispenser nozzle (e.g., from the bottom of the well). In some embodiments, the height of the aspirator nozzle is within 1 mm from the height of the dispenser nozzle. In some embodiments, the height of the aspirator nozzle is within 0.1 mm from the height of the dispenser nozzle.

In some embodiments, an aspiration rate for aspirating the liquid through the aspirator nozzle is less than a predefined aspiration rate (e.g., the predefined aspiration rate is less than 1 μL/s, 2 μL/s, 3 L/s, 4 L/s, 5 L/s, 6 μL/s, 7 μL/s, 8 μL/s, 9 L/s, 10 μL/s, 11 μL/s, 12 μL/s, 13 μL/s, 14 μL/s, 15 μL/s, 16 μL/s, 17 μL/s, 18 μL/s, 19 μL/s, 20 μL/s, 25 μL/s, 30 μL/s, 35 μL/s, 40 μL/s, 45 μL/s, or 50 μL/s).

In some embodiments, the stored instructions include instructions for sending one or more signals to the aspirator for aspirating the liquid at different aspiration rates based on a height of the tip of the aspirator nozzle (e.g., from a bottom of the well). In some embodiments, the aspiration rate is reduced monotonically as the height of the tip of the aspirator nozzle decreases.

In some embodiments, the stored instructions include instructions for sending one or more signals to the aspirator for aspirating the liquid at a first aspiration rate at a first height of the tip of the aspirator nozzle and instructions for sending one or more signals to the aspirator for aspirating the liquid at a second aspiration rate distinct from the first aspiration rate at a second height of the tip of the aspirator nozzle that is distinct from the first height.

In some embodiments, the first height is greater than the second height and the first aspiration rate is greater than the second aspiration rate.

In some embodiments, the stored instructions also include instructions for sending one or more signals to the aspirator for aspirating the liquid at a third aspiration rate distinct from the first aspiration rate and the second aspiration rate at a third height of the tip of the aspirator nozzle distinct from the first height and the second height.

In some embodiments, the second height is greater than the third height and the second aspiration rate is greater than the third aspiration rate.

In some embodiments, the aspirator nozzle is positioned to be adjacent to a wall of the well (e.g., within 0.1 mm, 0.2 mm, 0.3 mm, 0.4 mm, 0.5 mm, 0.6 mm, 0.7 mm, 0.8 mm, 0.9 mm, 1.0 mm, 1.1 mm, 1.2 mm, 1.3 mm, 1.4 mm, 1.5 mm, 1.6 mm, 1.7 mm, 1.8 mm, 1.9 mm, 2 mm, 3 mm, 4 mm, 5 mm, 6 mm, 7 mm, 8 mm, 9 mm, 10 mm, or within 5%, 10%, 15%, 20%, 25%, or 30% of the diameter of the well from the wall of the well).

In some embodiments, the stored instructions include instructions for moving the aspirator nozzle laterally as a function of a height of the aspirator nozzle.

In some embodiments, the well has a flat bottom.

In some embodiments, the well has a chamfered or rounded corner between the flat bottom and a wall of the well.

In some embodiments, the well has a round bottom.

In accordance with some embodiments, a method includes placing a tip of a dispenser nozzle in contact with a sample liquid in a well at a location adjacent to a top liquid surface of the sample liquid while a dispenser dispenses a wash liquid through the dispenser nozzle to the sample liquid.

In some embodiments, the method also includes placing the tip of the dispenser nozzle within a predefined distance (e.g., less than 0.1 mm, 0.2 mm, 0.3 mm, 0.4 mm, 0.5 mm, 0.6 mm, 0.7 mm, 0.8 mm, 0.9 mm, 1.0 mm, 1.1 mm, 1.2 mm, 1.3 mm, 1.4 mm, 1.5 mm, 1.6 mm, 1.7 mm, 1.8 mm, 1.9 mm, 2.0 mm, 2.1 mm, 2.2 mm, 2.3 mm, 2.4 mm, or 2.5 mm, or between any two of the aforementioned distances) below the top liquid surface of the sample liquid.

In some embodiments, the method includes dispensing the wash liquid through the dispenser nozzle at a dispensing rate less than a predefined dispense rate (e.g., the predefined dispense rate is 1 μL/s, 2 L/s, 3 L/s, 4 μL/s, 5 μL/s, 6 L/s, 7 L/s, 8 μL/s, 9 μL/s, 10 μL/s, 11 μL/s, 12 μL/s, 13 L/s, 14 μL/s, 15 μL/s, 16 μL/s, 17 μL/s, 18 μL/s, 19 μL/s, 20 L/s, 25 μL/s, 30 μL/s, 35 μL/s, 40 μL/s, 45 L/s, or 50 μL/s).

In some embodiments, the method includes dispensing the wash liquid at different dispensing rates based on a height of the tip of the dispenser nozzle.

In some embodiments, the method includes dispensing the wash liquid at a first dispensing rate at a first height of the tip of the dispenser nozzle: and dispensing the wash liquid at a second dispensing rate distinct from the first dispensing rate at a second height of the tip of the dispenser nozzle that is distinct from the first height.

In some embodiments, the first height is greater than the second height and the first dispensing rate is greater than the second dispensing rate.

In some embodiments, the method includes dispensing the wash liquid at a third dispensing rate distinct from the first dispensing rate and the second dispensing rate at a third height of the tip of the dispenser nozzle distinct from the first height and the second height.

In some embodiments, the second height is greater than the third height and the second dispensing rate is greater than the third dispensing rate.

In some embodiments, the method includes placing the dispenser nozzle adjacent to a lateral center of the well.

In some embodiments, the tip of the dispenser nozzle is angled toward a wall of the well.

In some embodiments, the method includes placing a tip of an aspirator nozzle for aspirating a liquid from the sample liquid.

In some embodiments, the method includes lowering the aspirator nozzle so that the aspirator nozzle is in contact with the sample solution for aspirating the liquid from the sample solution: subsequent to lowering the aspirator nozzle, lifting the aspirator nozzle so that the aspirator nozzle ceases to be in contact with a top surface of the sample solution; and, subsequent to lifting the aspirator nozzle, lowering the aspirator nozzle so that the aspirator nozzle is in contact with the sample solution for aspirating the liquid from the sample solution.

In some embodiments, the method includes repeating the lifting operation and the lowering operation (e.g., until the remaining solution has a predefined height).

In some embodiments, the method includes placing the aspirator nozzle within a predefined distance from the top surface of the sample (e.g., the predefined distance is 100 μm, 200 μm, 300 μm, 400 μm, 500 μm, 600 μm, 700 μm, 800 μm, 900 μm, or 1000 μm).

In some embodiments, the aspirator nozzle is positioned relative to the dispenser nozzle so that a height of the aspirator nozzle (e.g., from a bottom of the well) is greater than a height of the dispenser nozzle (e.g., from the bottom of the well).

In some embodiments, an aspiration rate for aspirating the liquid through the aspirator nozzle is less than a predefined aspiration rate (e.g., the predefined aspiration rate is less than 1 μL/s, 2 μL/s, 3 μL/s, 4 L/s, 5 μL/s, 6 μL/s, 7 μL/s, 8 L/s, 9 μL/s, 10 μL/s, 11 μL/s, 12 μL/s, 13 μL/s, 14 μL/s, 15 μL/s, 16 μL/s, 17 μL/s, 18 μL/s, 19 μL/s, 20 μL/s, 25 μL/s, 30 μL/s, 35 μL/s, 40 μL/s, 45 μL/s, or 50 μL/s).

In some embodiments, the method includes aspirating the liquid at different aspiration rates based on a height of the tip of the aspirator nozzle (e.g., from a bottom of the well).

In some embodiments, the method includes aspirating the liquid at a first aspiration rate at a first height of the tip of the aspirator nozzle: and aspirating the liquid at a second aspiration rate distinct from the first aspiration rate at a second height of the tip of the aspirator nozzle that is distinct from the first height.

In some embodiments, the first height is greater than the second height and the first aspiration rate is greater than the second aspiration rate.

In some embodiments, the method includes aspirating the liquid at a third aspiration rate distinct from the first aspiration rate and the second aspiration rate at a third height of the tip of the aspirator nozzle distinct from the first height and the second height.

In some embodiments, the second height is greater than the third height and the second aspiration rate is greater than the third aspiration rate.

In some embodiments, the aspirator nozzle is positioned to be adjacent to a wall of the well (e.g., within 0.1 mm, 0.2 mm, 0.3 mm, 0.4 mm, 0.5 mm, 0.6 mm, 0.7 mm, 0.8 mm, 0.9 mm, 1.0 mm, 1.1 mm, 1.2 mm, 1.3 mm, 1.4 mm, 1.5 mm, 1.6 mm, 1.7 mm, 1.8 mm, 1.9 mm, 2 mm, 3 mm, 4 mm, 5 mm, 6 mm, 7 mm, 8 mm, 9 mm, 10 mm, or within 5%, 10%, 15%, 20%, 25%, or 30% of the diameter of the well from the wall of the well).

In some embodiments, the method includes moving the aspirator nozzle laterally as a function of a height of the aspirator nozzle.

In some embodiments, the well has a round bottom.

In some embodiments, the well has a flat bottom.

In some embodiments, the well has a chamfered or rounded corner between the flat bottom and a wall of the well.

In some embodiments, the method includes obtaining an image of a sample in the well through the flat bottom.

In accordance with some embodiments, a device includes a first chamber; a first one-way valve in fluidic communication with the chamber for allowing a liquid flow into the first chamber through the first one-way valve and restricting a liquid flow out of the first chamber through the first one-way valve: and a second one-way valve in fluidic communication with the chamber for allowing a liquid flow out of the first chamber through the second one-way valve and restricting a liquid flow into the first chamber through the second one-way valve.

In some embodiments, the first one-way valve is coupled with a first portion of the first chamber: and the second one-way valve is coupled with a second portion of the first chamber that is distinct from the first portion of the first chamber.

In some embodiments, the device includes a multi-channel connector having at least three ports. A first port of the three ports is in fluidic communication with the first chamber. A second port of the three ports is in fluidic communication with the first one-way valve. A third port of the three ports is in fluidic communication with the second one-way valve.

In some embodiments, the first chamber includes a syringe and a piston slidably coupled with the syringe for sliding at least partially within the syringe.

In some embodiments, the first chamber includes a wall, at least a portion of the wall being made of a flexible material; and the device also includes a mechanical component for causing deformation of the flexible material so that the deformation of the flexible material causes a liquid within the first chamber to be dispensed from the first chamber.

In some embodiments, the first chamber includes a wall, at least a portion of the wall being made of a flexible material; the device also includes a pressure chamber for providing different pressures: and at least a portion of the flexible material of the first chamber is positioned within the pressure chamber so that a change in a pressure within the pressure chamber causes deformation of the flexible material of the first chamber.

In some embodiments, the pressure chamber is coupled to a syringe and a piston coupled slidingly with the syringe for changing the pressure within the pressure chamber.

In some embodiments, the device includes a second chamber; a third one-way valve in fluidic communication with the second chamber for allowing a liquid flow into the second chamber through the third one-way valve and restricting a liquid flow out of the second chamber through the third one-way valve: and a fourth one-way valve in fluidic communication with the second chamber for allowing a liquid flow out of the second chamber through the fourth one-way valve and restricting a liquid flow into the second chamber through the fourth one-way valve. The second chamber includes a wall, at least a portion of the wall being made of a flexible material. At least a portion of the flexible material of the second chamber is positioned within the pressure chamber so that the change in the pressure within the pressure chamber causes deformation of the flexible material of the second chamber.

In some embodiments, the device includes one or more additional chambers, each additional chamber in fluidic communication with a respective set of two or more one-way valves.

In some embodiments, the change in the pressure within the pressure chamber causes concurrent deformation of the flexible material of the first chamber and the flexible material of the second chamber.

In some embodiments, the first chamber includes a wall; and the device also includes an acoustic pressure generator coupled with the wall of the first chamber for causing deformation of the wall.

In some embodiments, the device includes one or more temperature changing components coupled with the first chamber for changing a temperature of a liquid within the first chamber.

In some embodiments, the one or more temperature changing components include a heating element for increasing the temperature of the liquid within the first chamber.

In some embodiments, the one or more temperature changing components include a cooling element for decreasing the temperature of the liquid within the first chamber.

In accordance with some embodiments, a method includes moving a liquid into a first chamber through a first one-way valve: and moving at least a portion of the liquid out of the first chamber through a second one-way valve.

In some embodiments, the liquid is moved into the first chamber by lowering a pressure within the first chamber: and the liquid is moved out of the first chamber by increasing a pressure within the first chamber.

In some embodiments, the first chamber includes a syringe and a piston slidably coupled with the syringe for changing a pressure within the first chamber.

In some embodiments, the first chamber includes a wall, at least a portion of the wall being made of a flexible material. The method also includes causing, with a mechanical component, deformation of the flexible material for moving at least a portion of the liquid out of the first chamber.

In some embodiments, the first chamber includes a wall, at least a portion of the wall being made of a flexible material: at least a portion of the flexible material is positioned within a pressure chamber: and the method also includes changing a pressure within the pressure chamber for causing deformation of the flexible material of the first chamber so that at least a portion of the liquid in the first chamber is moved out of the first chamber.

In some embodiments, at least a portion of a flexible material of a wall of a second chamber is positioned within the pressure chamber, the second chamber in fluidic communication with at least two one-way valves: and changing the pressure within the pressure chamber also causes deformation of the flexible material of the second chamber so that at least a portion of a liquid in the second chamber is moved out of the second chamber.

In some embodiments, changing the pressure within the pressure chamber also causes deformation of a flexible material of one or more additional chambers, a respective chamber of the one or more additional chambers in fluidic communication with at least two one-way valves, so that at least a portion of a liquid in a respective chamber of the one or more additional chambers is moved out of the respective chamber.

In some embodiments, the change in the pressure within the pressure chamber causes concurrent deformation of the flexible material of the first chamber and the flexible material of the second chamber.

In some embodiments, the method includes providing an acoustic pressure to a wall of the first chamber for causing deformation of the wall so that the deformation of the wall moves at least a portion of the liquid out of the first chamber.

In some embodiments, the method includes causing expansion of the liquid within the first chamber so that at least a portion of the liquid within the first chamber is moved out of the first chamber.

In some embodiments, the method includes increasing a temperature of the liquid within the first chamber so that the liquid within the first chamber expands.

In some embodiments, the method includes decreasing a temperature of the liquid within the first chamber so that the liquid within the first chamber contracts.

In accordance with some embodiments, a device includes a plate with one or more wells for holding sample solutions, the plate having a top surface and a bottom surface. A bottom surface of a respective well of the one or more wells is substantially flat. A portion of the plate adjacent to the bottom surface of the respective well is substantially transparent.

In some embodiments, the plate includes a substantially transparent substrate (e.g., a glass substrate) adjacent to the bottom surface of the plate.

In some embodiments, the respective well is defined by the substantially flat bottom surface and a side wall.

In some embodiments, the respective well has a rounded corner adjoining the bottom surface of the respective well and the side wall.

In some embodiments, the bottom surface is made of a hydrophilic material and the side wall is made of a hydrophobic material.

In some embodiments, the respective well has a first cross-sectional area adjacent to the bottom surface of the plate and a second cross-sectional area adjacent to the top surface of the plate, the second cross-sectional area being greater than the first cross-sectional area.

In some embodiments, the first cross-sectional area is characterized by a first diameter and the second cross-sectional area is characterized by a second diameter greater than the first diameter.

In accordance with some embodiments, a method includes obtaining any device (e.g., a plate) described herein. The device includes a sample solution in a well defined in the device. The method also includes dispensing a wash solution into the well and aspirating a solution from the well so that one or more samples in the sample solution are washed.

In accordance with some embodiments, a method includes obtaining any device described herein. The method also includes obtaining an image of a sample in the device through the substantially transparent substrate.

In accordance with some embodiments, an apparatus includes a first dispenser defining a first chamber. The first dispenser includes: a first nozzle coupled with the first chamber; and a first one-way valve in fluidic communication with the first chamber for allowing a liquid flow out of the first chamber through the first one-way valve and restricting a liquid flow into the first chamber through the first one-way valve. The apparatus also includes a dispenser pump in fluidic communication with the first chamber to provide liquid into the first chamber.

In some embodiments, the first dispenser also includes a first piston configured to slide at least partially within the first chamber.

In some embodiments, the first one-way valve is located between the first chamber and the first nozzle to allow a liquid flow out of the first chamber through the first one-way valve to the first nozzle and restrict a liquid flow from the first nozzle to the first chamber through the first one-way valve.

In some embodiments, the first dispenser also includes a second one-way valve in fluidic communication with the first chamber for allowing a liquid flow from the dispenser pump into the first chamber through the second one-way valve and restricting a liquid flow out of the first chamber to the dispenser pump through the second one-way valve.

In some embodiments, the apparatus includes a second dispenser defining a second chamber. The second dispenser includes a second nozzle coupled with the second chamber: and a third one-way valve in fluidic communication with the second chamber for allowing a liquid flow out of the second chamber through the third one-way valve and restricting a liquid flow into the second chamber through the third one-way valve. The dispenser pump is in fluidic communication with the second chamber to provide liquid into the second chamber.

In some embodiments, the second dispenser also includes a second piston configured to slide at least partially within the second chamber.

In some embodiments, the third one-way valve is located between the second chamber and the second nozzle to allow a liquid flow out of the second chamber through the third one-way valve to the second nozzle and restrict a liquid flow from the second nozzle to the second chamber through the third one-way valve.

In some embodiments, the second dispenser also includes a fourth one-way valve in fluidic communication with the second chamber for allowing a liquid flow from the dispenser pump into the first chamber through the fourth one-way valve and restricting a liquid flow out of the second chamber to the dispenser pump through the fourth one-way valve.

In some embodiments, the dispenser pump provides the liquid into the first chamber and the second chamber concurrently.

In some embodiments, the apparatus includes a first aspirator defining a third chamber. The first aspirator includes: a third nozzle coupled with the third chamber; and a fifth one-way valve in fluidic communication with the third chamber for allowing a liquid flow into the third chamber through the fifth one-way valve and restricting a liquid flow out of the third chamber through the fifth one-way valve. The apparatus also includes an aspirator pump in fluidic communication with the third chamber to move liquid from the third chamber.

In some embodiments, the first aspirator also includes a third piston configured to slide at least partially within the third chamber.

In some embodiments, the fifth one-way valve is located between the third chamber and the third nozzle to allow a liquid flow into the third chamber through the fifth one-way valve and restrict a liquid flow out of the third chamber to the third nozzle through the fifth one-way valve.

In some embodiments, the first aspirator also includes a sixth one-way valve in fluidic communication with the third chamber for allowing a liquid flow from the third chamber to the aspirator pump through the sixth one-way valve and restrict a liquid flow into the third chamber from the aspirator pump through the sixth one-way valve.

In some embodiments, the apparatus includes a second aspirator defining a fourth chamber. The second aspirator includes a fourth nozzle coupled with the fourth chamber; and a seventh one-way valve in fluidic communication with the fourth chamber for allowing a liquid flow into the fourth chamber through the seventh one-way valve and restricting a liquid flow out of the fourth chamber through the seventh one-way valve. The aspirator pump is in fluidic communication with the fourth chamber to move liquid from the fourth chamber.

In some embodiments, the second aspirator also includes a fourth piston configured to slide at least partially within the fourth chamber.

In some embodiments, the seventh one-way valve is located between the fourth chamber and the fourth nozzle to allow a liquid flow into the fourth chamber from the fourth nozzle through the seventh one-way valve and restrict a liquid flow out of the fourth chamber to the fourth nozzle through the seventh one-way valve.

In some embodiments, the second aspirator also includes an eighth one-way valve in fluidic communication with the fourth chamber for allowing a liquid flow from the fourth chamber to the aspirator pump through the eighth one-way valve and restricting a liquid flow into the fourth chamber from the aspirator pump through the eighth one-way valve.

In some embodiments, the aspirator pump moves liquid from the third chamber and the fourth chamber to the aspirator pump concurrently.

In some embodiments, the aspirator pump includes a vacuum pump.

In accordance with some embodiments, an apparatus includes a first aspirator defining a first chamber. The first aspirator includes a first nozzle coupled with the first chamber: and a first one-way valve in fluidic communication with the first chamber for allowing a liquid flow into the first chamber through the first one-way valve and restricting a liquid flow out of the first chamber through the first one-way valve. The apparatus also includes an aspirator pump in fluidic communication with the first chamber to move liquid from the first chamber.

In some embodiments, the first aspirator also includes a first piston configured to slide at least partially within the first chamber.

In some embodiments, the first one-way valve is located between the first chamber and the first nozzle to allow a liquid flow into the first chamber through the first one-way valve and restrict a liquid flow out of the first chamber to the first nozzle through the first one-way valve.

In some embodiments, the first aspirator also includes a second one-way valve in fluidic communication with the first chamber for allowing a liquid flow from the first chamber to the aspirator pump through the second one-way valve and restrict a liquid flow into the first chamber from the aspirator pump through the second one-way valve.

In some embodiments, the apparatus includes a second aspirator defining a second chamber. The second aspirator includes: a second nozzle coupled with the second chamber: and a third one-way valve in fluidic communication with the second chamber for allowing a liquid flow into the second chamber through the third one-way valve and restricting a liquid flow out of the second chamber through the third one-way valve. The aspirator pump is in fluidic communication with the second chamber to move liquid from the second chamber.

In some embodiments, the second aspirator also includes a second piston configured to slide at least partially within the second chamber.

In some embodiments, the third one-way valve is located between the second chamber and the second nozzle to allow a liquid flow into the second chamber from the second nozzle through the third one-way valve and restrict a liquid flow out of the second chamber to the second nozzle through the third one-way valve.

In some embodiments, the second aspirator also includes a fourth one-way valve in fluidic communication with the second chamber for allowing a liquid flow from the second chamber to the aspirator pump through the fourth one-way valve and restrict a liquid flow into the second chamber from the aspirator pump through the fourth one-way valve.

In some embodiments, the aspirator pump moves liquid from the first chamber and the second chamber to the aspirator pump concurrently.

In some embodiments, the aspirator pump includes a vacuum pump.

In accordance with some embodiments, a method includes dispensing a first volume of liquid from a first dispenser, the first dispenser defining a first chamber and including a first piston configured to slide at least partially within the first chamber, a first nozzle coupled with the first chamber, and a first one-way valve in fluidic communication with the first chamber for allowing a liquid flow out of the first chamber through the first one-way valve and restricting a liquid flow into the first chamber through the first one-way valve. The first volume of liquid is dispensed from the first dispenser by moving the first piston. The method also includes dispensing a second volume of liquid from the first dispenser using a dispenser pump in fluidic communication with the first chamber to provide liquid into the first chamber. The second volume is distinct from the first volume.

In some embodiments, the first one-way valve is located between the first chamber and the first nozzle to allow a liquid flow out of the first chamber through the first one-way valve to the first nozzle and restrict a liquid flow from the first nozzle to the first chamber through the first one-way valve.

In some embodiments, the first dispenser also includes a second one-way valve in fluidic communication with the first chamber for allowing a liquid flow from the dispenser pump into the first chamber through the second one-way valve and restricting a liquid flow out of the first chamber to the dispenser pump through the second one-way valve.

In some embodiments, the second volume is greater than the first volume.

In some embodiments, the method includes dispensing a third volume of liquid from a second dispenser, the second dispenser defining a second chamber and including a second piston configured to slide at least partially within the second chamber, a second nozzle coupled with the second chamber, a third one-way valve in fluidic communication with the second chamber for allowing a liquid flow out of the second chamber through the third one-way valve and restricting a liquid flow into the second chamber through the third one-way valve. The third volume is dispensed from the second dispenser by moving the second piston. The method also includes dispensing a fourth volume of liquid from the second dispenser using the dispenser pump in fluidic communication with the second chamber to provide liquid into the second chamber. The fourth volume is distinct from the third volume.

In some embodiments, the third one-way valve is located between the second chamber and the second nozzle to allow a liquid flow out of the second chamber through the third one-way valve to the second nozzle and restrict a liquid flow from the second nozzle to the second chamber through the third one-way valve.

In some embodiments, the second dispenser also includes a fourth one-way valve in fluidic communication with the second chamber for allowing a liquid flow from the dispenser pump into the first chamber through the fourth one-way valve and restricting a liquid flow out of the second chamber to the dispenser pump through the fourth one-way valve.

In some embodiments, the fourth volume is greater than the third volume.

In some embodiments, the method includes providing liquid from the dispenser pump into the first chamber and the second chamber concurrently.

In some embodiments, the method includes aspirating a fifth volume of liquid with a first aspirator, the first aspirator defining a third chamber, the first aspirator including a third piston configured to slide at least partially within the third chamber, a third nozzle coupled with the third chamber, and a fifth one-way valve in fluidic communication with the third chamber for allowing a liquid flow into the third chamber through the fifth one-way valve and restricting a liquid flow out of the third chamber through the fifth one-way valve. The fifth volume of liquid is aspirated with the first aspirator by moving the third piston. The method also includes aspirating a sixth volume of liquid with the first aspirator using an aspirator pump in fluidic communication with the third chamber to move liquid from the third chamber. The sixth volume is distinct from the fifth volume.

In some embodiments, the fifth one-way valve is located between the third chamber and the third nozzle to allow a liquid flow into the third chamber through the fifth one-way valve and restrict a liquid flow out of the third chamber to the third nozzle through the fifth one-way valve.

In some embodiments, the first aspirator also includes a sixth one-way valve in fluidic communication with the third chamber for allowing a liquid flow from the third chamber to the aspirator pump through the sixth one-way valve and restrict a liquid flow into the third chamber from the aspirator pump through the sixth one-way valve.

In some embodiments, the sixth volume is greater than the fifth volume.

In some embodiments, the method includes aspirating a seventh volume of liquid with a second aspirator defining a fourth chamber, the second aspirator including a fourth piston configured to slide at least partially within the fourth chamber, a fourth nozzle coupled with the fourth chamber, and a seventh one-way valve in fluidic communication with the fourth chamber for allowing a liquid flow into the fourth chamber through the seventh one-way valve and restricting a liquid flow out of the fourth chamber through the seventh one-way valve. The seventh volume of liquid is aspirated with the second aspirator by moving the fourth piston. The method also includes aspirating an eighth volume of liquid with the second aspirator using the aspirator pump in fluidic communication with the fourth chamber to move liquid from the fourth chamber. The eighth volume is distinct from the seventh volume.

In some embodiments, the seventh one-way valve is located between the fourth chamber and the fourth nozzle to allow a liquid flow into the fourth chamber from the fourth nozzle through the seventh one-way valve and restrict a liquid flow out of the fourth chamber to the fourth nozzle through the seventh one-way valve.

In some embodiments, the second aspirator also includes an eighth one-way valve in fluidic communication with the fourth chamber for allowing a liquid flow from the fourth chamber to the aspirator pump through the eighth one-way valve and restricting a liquid flow into the fourth chamber from the aspirator pump through the eighth one-way valve.

In some embodiments, the eighth volume is greater than the seventh volume.

In some embodiments, the method includes aspirating liquid into the third chamber and the fourth chamber concurrently using the aspirator pump.

In some embodiments, the aspirator pump includes a vacuum pump.

In accordance with some embodiments, a method includes aspirating a first volume of liquid with a first aspirator defining a first chamber, the first aspirator including a first piston configured to slide at least partially within the first chamber, a first nozzle coupled with the first chamber, and a first one-way valve in fluidic communication with the first chamber for allowing a liquid flow into the first chamber through the first one-way valve and restricting a liquid flow out of the first chamber through the first one-way valve. The first volume of liquid is aspirated with the first aspirator by moving the first piston. The method also includes aspirating a second volume of liquid with the first aspirator using an aspirator pump in fluidic communication with the first chamber to move liquid from the first chamber. The second volume is distinct from the first volume.

In some embodiments, the first one-way valve is located between the first chamber and the first nozzle to allow a liquid flow into the first chamber through the first one-way valve and restrict a liquid flow out of the first chamber to the first nozzle through the first one-way valve.

In some embodiments, the first aspirator also includes a second one-way valve in fluidic communication with the first chamber for allowing a liquid flow from the first chamber to the aspirator pump through the second one-way valve and restrict a liquid flow into the first chamber from the aspirator pump through the second one-way valve.

In some embodiments, the second volume is greater than the first volume.

In some embodiments, the method includes aspirating a third volume of liquid with a second aspirator defining a second chamber, the second aspirator including a second piston configured to slide at least partially within the second chamber, a second nozzle coupled with the second chamber, and a third one-way valve in fluidic communication with the second chamber for allowing a liquid flow into the second chamber through the third one-way valve and restricting a liquid flow out of the second chamber through the third one-way valve. The third volume of liquid is aspirated with the second aspirator by moving the second piston. The method also includes aspirating a fourth volume of liquid with the second aspirator using the aspirator pump in fluidic communication with the second chamber to move liquid from the second chamber. The fourth volume is distinct from the third volume.

In some embodiments, the third one-way valve is located between the second chamber and the second nozzle to allow a liquid flow into the second chamber from the second nozzle through the third one-way valve and restrict a liquid flow out of the second chamber to the second nozzle through the third one-way valve.

In some embodiments, the second aspirator also includes a fourth one-way valve in fluidic communication with the second chamber for allowing a liquid flow from the second chamber to the aspirator pump through the fourth one-way valve and restrict a liquid flow into the second chamber from the aspirator pump through the fourth one-way valve.

In some embodiments, the fourth volume is greater than the third volume.

In some embodiments, the method includes aspirating liquid into the first chamber and the second chamber to the aspirator pump concurrently using the aspirator pump.

In some embodiments, the aspirator pump includes a vacuum pump.

It is well known to a person having ordinary skill in the art that plates can be used in many other biological and chemical reactions. Therefore, such details and specific examples are omitted for brevity.

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

Some embodiments may be described with respect to the following clauses:

Clause 1. An apparatus for washing a sample in a sample liquid in a well on a plate, the apparatus comprising:
a dispenser with a dispenser nozzle for dispensing a wash liquid to the sample liquid;
a dispenser actuator coupled with the dispenser nozzle;
one or more processors; and
memory storing instructions for execution by the one or more processors, the stored instructions including instructions for sending one or more signals to the dispenser actuator for placing a tip of the dispenser nozzle in contact with the sample liquid at a location adjacent to a top liquid surface of the sample liquid for dispensing the wash liquid through the dispenser nozzle.

Clause 2. The apparatus of clause 1, wherein:
the stored instructions include instructions for sending one or more signals to the dispense actuator for placing the tip of the dispenser nozzle within a predefined distance, below the top liquid surface of the sample liquid.

Clause 3. The apparatus of clause 1 or 2, wherein:
a dispensing rate for dispensing the wash liquid through the dispenser nozzle is less than a predefined dispense rate.

Clause 4. The apparatus of any of clauses 1-3, wherein:
the stored instructions include instructions for sending one or more signals to the dispenser for dispensing the wash liquid at different dispensing rates based on a height of the tip of the dispenser nozzle.

Clause 5. The apparatus of any of clauses 1-4, wherein the stored instructions include instructions for sending one or more signals to the dispenser for dispensing the wash liquid at a first dispensing rate at a first height of the tip of the dispenser nozzle and instructions for sending one or more signals to the dispenser for dispensing the wash liquid at a second dispensing rate distinct from the first dispensing rate at a second height of the tip of the dispenser nozzle that is distinct from the first height.

Clause 6. The apparatus of clause 5, wherein the first height is greater than the second height and the first dispensing rate is greater than the second dispensing rate.

Clause 7. The apparatus of clause 5 or 6, wherein the stored instructions also include instructions for sending one or more signals to the dispenser for dispensing the wash liquid at a third dispensing rate distinct from the first dispensing rate and the second dispensing rate at a third height of the tip of the dispenser nozzle distinct from the first height and the second height.

Clause 8. The apparatus of clause 7, wherein the second height is greater than the third height and the second dispensing rate is greater than the third dispensing rate.

Clause 9. The apparatus of any of clauses 1-8, wherein:
the dispenser nozzle is positioned to be adjacent to a lateral center of the well.

Clause 10. The apparatus of any of clauses 1-9, wherein:
the tip of the dispenser nozzle is angled toward a wall of the well.

Clause 11. The apparatus of any of clauses 1-10, further comprising:
an aspirator with an aspirator nozzle for aspirating a liquid from the sample liquid.

Clause 12. The apparatus of clause 11, further comprising:
an aspirator actuator coupled with the aspirator nozzle,
wherein the stored instructions include instructions for sending one or more signals to the aspirator actuator for placing a tip of the aspirator nozzle.

Clause 13. The apparatus of clause 12, wherein:
the stored instructions include instructions for sending one or more signals to the aspirator actuator for:
   lowering the aspirator nozzle so that the aspirator nozzle is in contact with the sample solution while the aspirator is aspirating the liquid from the sample solution;
   subsequent to lowering the aspirator nozzle, lifting the aspirator nozzle so that the aspirator nozzle ceases to be in contact with a top surface of the sample solution: and
   subsequent to lifting the aspirator nozzle, lowering the aspirator nozzle so that the aspirator nozzle is in contact with the sample solution while the aspirator is aspirating the liquid from the sample solution.

Clause 14. The apparatus of clause 13, wherein:
the stored instructions include instructions for sending one or more signals to the aspirator actuator for repeating the lifting operation and the lowering operation.

Clause 15. The apparatus of any of clauses 11-14, wherein:
the stored instructions include instructions for sending one or more signals to the aspirator actuator for placing the aspirator nozzle within a predefined distance from the top surface of the sample.

Clause 16. The apparatus of any of clauses 11-15, wherein:
the aspirator nozzle is positioned relative to the dispenser nozzle so that a height of the aspirator nozzle is greater than a height of the dispenser nozzle, or the height of the aspirator nozzle is substantially the same as the height of the dispenser nozzle.

Clause 17. The apparatus of any of clauses 11-16, wherein:
an aspiration rate for aspirating the liquid through the aspirator nozzle is less than a predefined aspiration rate.

Clause 18. The apparatus of any of clauses 11-17, wherein:
the stored instructions include instructions for sending one or more signals to the aspirator for aspirating the liquid at different aspiration rates based on a height of the tip of the aspirator nozzle.

Clause 19. The apparatus of any of clauses 11-18, wherein the stored instructions include instructions for sending one or more signals to the aspirator for aspirating the liquid at a first aspiration rate at a first height of the tip of the aspirator nozzle and instructions for sending one or more signals to the aspirator for aspirating the liquid at a second aspiration rate distinct from the first aspiration rate at a second height of the tip of the aspirator nozzle that is distinct from the first height.

Clause 20. The apparatus of clause 19, wherein the first height is greater than the second height and the first aspiration rate is greater than the second aspiration rate.

Clause 21. The apparatus of clause 19 or 20, wherein the stored instructions also include instructions for sending one or more signals to the aspirator for aspirating the liquid at a third aspiration rate distinct from the first aspiration rate and the second aspiration rate at a third height of the tip of the aspirator nozzle distinct from the first height and the second height.

Clause 22. The apparatus of clause 21, wherein the second height is greater than the third height and the second aspiration rate is greater than the third aspiration rate.

Clause 23. The apparatus of any of clauses 11-22, wherein:
the aspirator nozzle is positioned to be adjacent to a wall of the well.

Clause 24. The apparatus of any of clauses 11-22, wherein the stored instructions include instructions for moving the aspirator nozzle laterally as a function of a height of the aspirator nozzle.

Clause 25. The apparatus of any of clauses 1-24, wherein:
the well has a flat bottom.

Clause 26. The apparatus of clause 25, wherein:
the well has a chamfered or rounded corner between the flat bottom and a wall of the well.

Clause 27. The apparatus of any of clauses 1-24, wherein:
the well has a round bottom.

Clause 28. A method, comprising:
placing a tip of a dispenser nozzle in contact with a sample liquid in a well at a location adjacent to a top liquid surface of the sample liquid while a dispenser dispenses a wash liquid through the dispenser nozzle to the sample liquid.

Clause 29. The method of clause 28, including:
placing the tip of the dispenser nozzle within a predefined distance, below the top liquid surface of the sample liquid.

Clause 30. The method of clause 28 or 29, including:
dispensing the wash liquid through the dispenser nozzle at a dispensing rate less than a predefined dispense rate.

Clause 31. The method of any of clauses 28-30, including:
dispensing the wash liquid at different dispensing rates based on a height of the tip of the dispenser nozzle.

Clause 32. The method of any of clauses 28-31, including:
dispensing the wash liquid at a first dispensing rate at a first height of the tip of the dispenser nozzle; and
dispensing the wash liquid at a second dispensing rate distinct from the first dispensing rate at a second height of the tip of the dispenser nozzle that is distinct from the first height.

Clause 33. The method of clause 32, wherein the first height is greater than the second height and the first dispensing rate is greater than the second dispensing rate.

Clause 34. The method of clause 32 or 33, including:
dispensing the wash liquid at a third dispensing rate distinct from the first dispensing rate and the second dispensing rate at a third height of the tip of the dispenser nozzle distinct from the first height and the second height.

Clause 35. The method of clause 34, wherein the second height is greater than the third height and the second dispensing rate is greater than the third dispensing rate.

Clause 36. The method of any of clauses 28-35, including: placing the dispenser nozzle adjacent to a lateral center of the well.

Clause 37. The method of any of clauses 28-36, wherein:
the tip of the dispenser nozzle is angled toward a wall of the well.

Clause 38. The method of any of clauses 28-37, further comprising:
placing a tip of an aspirator nozzle for aspirating a liquid from the sample liquid.

Clause 39. The method of clause 38, further comprising:
lowering the aspirator nozzle so that the aspirator nozzle is in contact with the sample solution for aspirating the liquid from the sample solution;
subsequent to lowering the aspirator nozzle, lifting the aspirator nozzle so that the aspirator nozzle ceases to be in contact with a top surface of the sample solution: and
subsequent to lifting the aspirator nozzle, lowering the aspirator nozzle so that the aspirator nozzle is in contact with the sample solution for aspirating the liquid from the sample solution.

Clause 40. The method of clause 39, further comprising:
repeating the lifting operation and the lowering operation.

Clause 41. The method of any of clauses 38-40, including:
placing the aspirator nozzle within a predefined distance from the top surface of the sample.

Clause 42. The method of any of clauses 38-41, wherein:
the aspirator nozzle is positioned relative to the dispenser nozzle so that a height of the aspirator nozzle is greater than a height of the dispenser nozzle.

Clause 43. The method of any of clauses 38-42, wherein:
an aspiration rate for aspirating the liquid through the aspirator nozzle is less than a predefined aspiration rate.

Clause 44. The method of any of clauses 38-43, including:
aspirating the liquid at different aspiration rates based on a height of the tip of the aspirator nozzle.

Clause 45. The method of any of clauses 38-44, including:
aspirating the liquid at a first aspiration rate at a first height of the tip of the aspirator nozzle; and
aspirating the liquid at a second aspiration rate distinct from the first aspiration rate at a second height of the tip of the aspirator nozzle that is distinct from the first height.

Clause 46. The method of clause 45, wherein the first height is greater than the second height and the first aspiration rate is greater than the second aspiration rate.

Clause 47. The method of clause 45 or 46, further comprising:
aspirating the liquid at a third aspiration rate distinct from the first aspiration rate and the second aspiration rate at a third height of the tip of the aspirator nozzle distinct from the first height and the second height.

Clause 48. The method of clause 47, wherein the second height is greater than the third height and the second aspiration rate is greater than the third aspiration rate.

Clause 49. The method of any of clauses 38-48, wherein:
the aspirator nozzle is positioned to be adjacent to a wall of the well.

Clause 50. The method of any of clauses 38-49, further comprising:
moving the aspirator nozzle laterally as a function of a height of the aspirator nozzle.

Clause 51. The method of any of clauses 37-50, wherein:
the well has a round bottom.

Clause 52. The method of any of clauses 37-50, wherein:
the well has a flat bottom.

Clause 53. The method of clause 52, wherein:
the well has a chamfered or rounded corner between the flat bottom and a wall of the well.

Clause 54. The method of clause 52 or 53, further comprising:
obtaining an image of a sample in the well through the flat bottom.

Clause 55. A device, comprising:
a first chamber;
a first one-way valve in fluidic communication with the chamber for allowing a liquid flow into the first chamber through the first one-way valve and restricting a liquid flow out of the first chamber through the first one-way valve; and
a second one-way valve in fluidic communication with the chamber for allowing a liquid flow out of the first chamber through the second one-way valve and restricting a liquid flow into the first chamber through the second one-way valve.

Clause 56. The device of clause 55, wherein:
the first one-way valve is coupled with a first portion of the first chamber: and
the second one-way valve is coupled with a second portion of the first chamber that is distinct from the first portion of the first chamber.

Clause 57. The device of clause 55, further comprising:
a multi-channel connector having at least three ports, wherein:
   a first port of the three ports is in fluidic communication with the first chamber;
   a second port of the three ports is in fluidic communication with the first one-way valve: and
   a third port of the three ports is in fluidic communication with the second one-way valve.

Clause 58. The device of any of clauses 55-57, wherein:
the first chamber includes a syringe and a piston slidably coupled with the syringe for sliding at least partially within the syringe.

Clause 59. The device of any of clauses 55-57, wherein:
the first chamber includes a wall, at least a portion of the wall being made of a flexible material; and
the device also includes a mechanical component for causing deformation of the flexible material so that the deformation of the flexible material causes a liquid within the first chamber to be dispensed from the first chamber.

Clause 60. The device of any of clauses 55-57, wherein:
the first chamber includes a wall, at least a portion of the wall being made of a flexible material;
the device also includes a pressure chamber for providing different pressures; and
at least a portion of the flexible material of the first chamber is positioned within the pressure chamber so that a change in a pressure within the pressure chamber causes deformation of the flexible material of the first chamber.

Clause 61. The device of clause 60, wherein the pressure chamber is coupled to a syringe and a piston coupled slidingly with the syringe for changing the pressure within the pressure chamber.

Clause 62. The device of clause 60 or 61, further comprising:
a second chamber;
a third one-way valve in fluidic communication with the second chamber for allowing a liquid flow into the second chamber through the third one-way valve and restricting a liquid flow out of the second chamber through the third one-way valve; and
a fourth one-way valve in fluidic communication with the second chamber for allowing a liquid flow out of the second chamber through the fourth one-way valve and restricting a liquid flow into the second chamber through the fourth one-way valve,
wherein:
   the second chamber includes a wall, at least a portion of the wall being made of a flexible material; and
   at least a portion of the flexible material of the second chamber is positioned within the pressure chamber so that the change in the pressure within the pressure chamber causes deformation of the flexible material of the second chamber.

Clause 63. The device of clause 62, further comprising one or more additional chambers, each additional chamber in fluidic communication with a respective set of two or more one-way valves.

Clause 64. The device of clause 62 or 63, wherein the change in the pressure within the pressure chamber causes concurrent deformation of the flexible material of the first chamber and the flexible material of the second chamber.

Clause 65. The device of any of clauses 55-57, wherein:
the first chamber includes a wall; and
the device also includes an acoustic pressure generator coupled with the wall of the first chamber for causing deformation of the wall.

Clause 66. The device of any of clauses 55-57, further comprising:
one or more temperature changing components coupled with the first chamber for changing a temperature of a liquid within the first chamber.

Clause 67. The device of clause 66, wherein:
the one or more temperature changing components include a heating element for increasing the temperature of the liquid within the first chamber.

Clause 68. The device of clause 66 or 67, wherein:
the one or more temperature changing components include a cooling element for decreasing the temperature of the liquid within the first chamber.

Clause 69. A method, comprising:
moving a liquid into a first chamber through a first one-way valve: and
moving at least a portion of the liquid out of the first chamber through a second one-way valve.

Clause 70. The method of clause 69, wherein:
the liquid is moved into the first chamber by lowering a pressure within the first chamber; and
the liquid is moved out of the first chamber by increasing a pressure within the first chamber.

Clause 71. The method of clause 69 or 70, wherein:
the first chamber includes a syringe and a piston slidably coupled with the syringe for changing a pressure within the first chamber.

Clause 72. The method of any of clauses 69-71, wherein:
the first chamber includes a wall, at least a portion of the wall being made of a flexible material; and
the method also includes causing, with a mechanical component, deformation of the flexible material for moving at least a portion of the liquid out of the first chamber.

Clause 73. The method of any of clauses 69-71, wherein:
the first chamber includes a wall, at least a portion of the wall being made of a flexible material;
at least a portion of the flexible material is positioned within a pressure chamber; and
the method also includes changing a pressure within the pressure chamber for causing deformation of the flexible material of the first chamber so that at least a portion of the liquid in the first chamber is moved out of the first chamber.

Clause 74. The method of clause 73, wherein:
at least a portion of a flexible material of a wall of a second chamber is positioned within the pressure chamber, the second chamber in fluidic communication with at least two one-way valves; and
changing the pressure within the pressure chamber also causes deformation of the flexible material of the second chamber so that at least a portion of a liquid in the second chamber is moved out of the second chamber.

Clause 75. The method of clause 74, wherein:
changing the pressure within the pressure chamber also causes deformation of a flexible material of one or more additional chambers, a respective chamber of the one or more additional chambers in fluidic communication with at least two one-way valves, so that at least a portion of a liquid in a respective chamber of the one or more additional chambers is moved out of the respective chamber.

Clause 76. The method of clause 74 or 75, wherein the change in the pressure within the pressure chamber causes concurrent deformation of the flexible material of the first chamber and the flexible material of the second chamber.

Clause 77. The method of any of clauses 69-71, further comprising:
providing an acoustic pressure to a wall of the first chamber for causing deformation of the wall so that the deformation of the wall moves at least a portion of the liquid out of the first chamber.

Clause 78. The method of any of clauses 69-71, further comprising:
causing expansion of the liquid within the first chamber so that at least a portion of the liquid within the first chamber is moved out of the first chamber.

Clause 79. The method of any of clauses 69-71 and 78, including:
increasing a temperature of the liquid within the first chamber so that the liquid within the first chamber expands.

Clause 80. The method of any of clauses 69-71 and 78-79, including:
decreasing a temperature of the liquid within the first chamber so that the liquid within the first chamber contracts.

Clause 81. A device, comprising: a plate with one or more wells for holding sample solutions, the plate having a top
surface and a bottom surface, wherein:
   a bottom surface of a respective well of the one or more wells is substantially flat; and
   a portion of the plate adjacent to the bottom surface of the respective well is substantially transparent.

Clause 82. The device of clause 81, wherein:
the plate includes a substantially transparent substrate adjacent to the bottom surface of the plate.

Clause 83. The device of clause 81 or 82, wherein:
the respective well is defined by the substantially flat bottom surface and a side wall.

Clause 84. The device of clause 83, wherein:
the respective well has a rounded corner adjoining the bottom surface of the respective well and the side wall.

Clause 85. The device of clause 83 or 84, wherein:
the bottom surface is made of a hydrophilic material and the side wall is made of a hydrophobic material.

Clause 86. The device of any of clauses 81-85, wherein:
the respective well has a first cross-sectional area adjacent to the bottom surface of the plate and a second cross-sectional area adjacent to the top surface of the plate, the second cross-sectional area being greater than the first cross-sectional area.

Clause 87. The device of clause 86, wherein:
the first cross-sectional area is characterized by a first diameter and the second cross-sectional area is characterized by a second diameter greater than the first diameter.

Clause 88. A method, comprising:
obtaining the device of any of clauses 81-87, wherein the device includes a sample solution in a well defined in the device; and
dispensing a wash solution into the well and aspirating a solution from the well so that one or more samples in the sample solution are washed.

Clause 89. A method, comprising:
obtaining the device of clause 82; and
obtaining an image of a sample in the device through the substantially transparent substrate.

Clause 90. An apparatus, comprising:
a first dispenser defining a first chamber, the first dispenser including:
   a first nozzle coupled with the first chamber; and
   a first one-way valve in fluidic communication with the first chamber for allowing a liquid flow out of the first chamber through the first one-way valve and restricting a liquid flow into the first chamber through the first one-way valve; and
a dispenser pump in fluidic communication with the first chamber to provide liquid into the first chamber.

Clause 91. The apparatus of clause 90, wherein the first dispenser also includes a first piston configured to slide at least partially within the first chamber.

Clause 92. The apparatus of clause 90 or 91, wherein the first one-way valve is located between the first chamber and the first nozzle to allow a liquid flow out of the first chamber through the first one-way valve to the first nozzle and restrict a liquid flow from the first nozzle to the first chamber through the first one-way valve.

Clause 93. The apparatus of any of clauses 90-92, wherein:
the first dispenser also includes a second one-way valve in fluidic communication with the first chamber for allowing a liquid flow from the dispenser pump into the first chamber through the second one-way valve and restricting a liquid flow out of the first chamber to the dispenser pump through the second one-way valve.

Clause 94. The apparatus of any of clauses 90-93, further comprising:
a second dispenser defining a second chamber, the second dispenser including:
   a second nozzle coupled with the second chamber: and
   a third one-way valve in fluidic communication with the second chamber for allowing a liquid flow out of the second chamber through the third one-way valve and restricting a liquid flow into the second chamber through the third one-way valve,
wherein the dispenser pump is in fluidic communication with the second chamber to provide liquid into the second chamber.

Clause 95. The apparatus of clause 94, wherein the second dispenser also includes a second piston configured to slide at least partially within the second chamber.

Clause 96. The apparatus of clause 94 or 95, wherein the third one-way valve is located between the second chamber and the second nozzle to allow a liquid flow out of the second chamber through the third one-way valve to the second nozzle and restrict a liquid flow from the second nozzle to the second chamber through the third one-way valve.

Clause 97. The apparatus of any of clauses 94-96, wherein:
the second dispenser also includes a fourth one-way valve in fluidic communication with the second chamber for allowing a liquid flow from the dispenser pump into the first chamber through the fourth one-way valve and restricting a liquid flow out of the second chamber to the dispenser pump through the fourth one-way valve.

Clause 98. The apparatus of any of clauses 94-97, wherein:
the dispenser pump provides the liquid into the first chamber and the second chamber concurrently.

Clause 99. The apparatus of any of clauses 90-98, further comprising:
a first aspirator defining a third chamber, the first aspirator including:
   a third nozzle coupled with the third chamber; and
   a fifth one-way valve in fluidic communication with the third chamber for allowing a liquid flow into the third chamber through the fifth one-way valve and restricting a liquid flow out of the third chamber through the fifth one-way valve: and
an aspirator pump in fluidic communication with the third chamber to move liquid from the third chamber.

Clause 100. The apparatus of clause 99, wherein the first aspirator also includes a third piston configured to slide at least partially within the third chamber.

Clause 101. The apparatus of clause 99 or 100, wherein the fifth one-way valve is located between the third chamber and the third nozzle to allow a liquid flow into the third chamber through the fifth one-way valve and restrict a liquid flow out of the third chamber to the third nozzle through the fifth one-way valve.

Clause 102. The apparatus of any of clauses 99-101, wherein:
the first aspirator also includes a sixth one-way valve in fluidic communication with the third chamber for allowing a liquid flow from the third chamber to the aspirator pump through the sixth one-way valve and restrict a liquid flow into the third chamber from the aspirator pump through the sixth one-way valve.

Clause 103. The apparatus of any of clauses 99-102, further comprising:
a second aspirator defining a fourth chamber, the second aspirator including:
   a fourth nozzle coupled with the fourth chamber; and
   a seventh one-way valve in fluidic communication with the fourth chamber for allowing a liquid flow into the fourth chamber through the seventh one-way valve and restricting a liquid flow out of the fourth chamber through the seventh one-way valve,
wherein the aspirator pump is in fluidic communication with the fourth chamber to move liquid from the fourth chamber.

Clause 104. The apparatus of clause 103, wherein the second aspirator also includes a fourth piston configured to slide at least partially within the fourth chamber.

Clause 105. The apparatus of clause 103 or 104, wherein the seventh one-way valve is located between the fourth chamber and the fourth nozzle to allow a liquid flow into the fourth chamber from the fourth nozzle through the seventh one-way valve and restrict a liquid flow out of the fourth chamber to the fourth nozzle through the seventh one-way valve.

Clause 106. The apparatus of any of clauses 103-105, wherein:
the second aspirator also includes an eighth one-way valve in fluidic communication with the fourth chamber for allowing a liquid flow from the fourth chamber to the aspirator pump through the eighth one-way valve and restricting a liquid flow into the fourth chamber from the aspirator pump through the eighth one-way valve.

Clause 107. The apparatus of any of clauses 103-106, wherein:
the aspirator pump moves liquid from the third chamber and the fourth chamber to the aspirator pump concurrently.

Clause 108. The apparatus of any of clauses 103-107, wherein:
the aspirator pump includes a vacuum pump.

Clause 109. An apparatus, comprising:
a first aspirator defining a first chamber, the first aspirator including:
   a first nozzle coupled with the first chamber; and
   a first one-way valve in fluidic communication with the first chamber for allowing a liquid flow into the first chamber through the first one-way valve and restricting a liquid flow out of the first chamber through the first one-way valve; and
an aspirator pump in fluidic communication with the first chamber to move liquid from the first chamber.

Clause 110. The apparatus of clause 109, wherein the first aspirator also includes a first piston configured to slide at least partially within the first chamber.

Clause 111. The apparatus of clause 109 or 110, wherein the first one-way valve is located between the first chamber and the first nozzle to allow a liquid flow into the first chamber through the first one-way valve and restrict a liquid flow out of the first chamber to the first nozzle through the first one-way valve.

Clause 112. The apparatus of any of clauses 109-111, wherein:
the first aspirator also includes a second one-way valve in fluidic communication with the first chamber for allowing a liquid flow from the first chamber to the aspirator pump through the second one-way valve and restrict a liquid flow into the first chamber from the aspirator pump through the second one-way valve.

Clause 113. The apparatus of any of clauses 109-112, further comprising:
a second aspirator defining a second chamber, the second aspirator including:
   a second nozzle coupled with the second chamber; and
   a third one-way valve in fluidic communication with the second chamber for allowing a liquid flow into the second chamber through the third one-way valve and restricting a liquid flow out of the second chamber through the third one-way valve,
wherein the aspirator pump is in fluidic communication with the second chamber to move liquid from the second chamber.

Clause 114. The apparatus of clause 113, wherein the second aspirator also includes a second piston configured to slide at least partially within the second chamber.

Clause 115. The apparatus of clause 113 or 114, wherein the third one-way valve is located between the second chamber and the second nozzle to allow a liquid flow into the second chamber from the second nozzle through the third one-way valve and restrict a liquid flow out of the second chamber to the second nozzle through the third one-way valve.

Clause 116. The apparatus of any of clauses 113-115, wherein:
the second aspirator also includes a fourth one-way valve in fluidic communication with the second chamber for allowing a liquid flow from the second chamber to the aspirator pump through the fourth one-way valve and restrict a liquid flow into the second chamber from the aspirator pump through the fourth one-way valve.

Clause 117. The apparatus of any of clauses 113-116, wherein:
the aspirator pump moves liquid from the first chamber and the second chamber to the aspirator pump concurrently.

Clause 118. The apparatus of any of clauses 113-117, wherein:
the aspirator pump includes a vacuum pump.

Clause 119. A method comprising:
dispensing a first volume of liquid from a first dispenser, the first dispenser defining a first chamber and including a first piston configured to slide at least partially within the first chamber, a first nozzle coupled with the first chamber, and a first one-way valve in fluidic communication with the first chamber for allowing a liquid flow out of the first chamber through the first one-way valve and restricting a liquid flow into the first chamber through the first one-way valve, wherein the first volume of liquid is dispensed from the first dispenser by moving the first piston: and
dispensing a second volume of liquid from the first dispenser using a dispenser pump in fluidic communication with the first chamber to provide liquid into the first chamber, wherein the second volume is distinct from the first volume.

Clause 120. The method of clause 119, wherein the first one-way valve is located between the first chamber and the first nozzle to allow a liquid flow out of the first chamber through the first one-way valve to the first nozzle and restrict a liquid flow from the first nozzle to the first chamber through the first one-way valve.

Clause 121. The method of clause 119 or 120, wherein:
the first dispenser also includes a second one-way valve in fluidic communication with the first chamber for allowing a liquid flow from the dispenser pump into the first chamber through the second one-way valve and restricting a liquid flow out of the first chamber to the dispenser pump through the second one-way valve.

Clause 122. The method of any of clauses 119-121, wherein the second volume is greater than the first volume.

Clause 123. The method of any of clauses 119-122, further comprising:
dispensing a third volume of liquid from a second dispenser, the second dispenser defining a second chamber and including a second piston configured to slide at least partially within the second chamber, a second nozzle coupled with the second chamber, a third one-way valve in fluidic communication with the second chamber for allowing a liquid flow out of the second chamber through the third one-way valve and restricting a liquid flow into the second chamber through the third one-way valve, wherein the third volume is dispensed from the second dispenser by moving the second piston; and
dispensing a fourth volume of liquid from the second dispenser using the dispenser pump in fluidic communication with the second chamber to provide liquid into the second chamber, wherein the fourth volume is distinct from the third volume.

Clause 124. The method of clause 123, wherein the third one-way valve is located between the second chamber and the second nozzle to allow a liquid flow out of the second chamber through the third one-way valve to the second nozzle and restrict a liquid flow from the second nozzle to the second chamber through the third one-way valve.

Clause 125. The method of clause 123 or 124, wherein:
the second dispenser also includes a fourth one-way valve in fluidic communication with the second chamber for allowing a liquid flow from the dispenser pump into the first chamber through the fourth one-way valve and restricting a liquid flow out of the second chamber to the dispenser pump through the fourth one-way valve.

Clause 126. The method of any of clauses 123-125, wherein the fourth volume is greater than the third volume.

Clause 127. The method of any of clauses 123-126, including:
providing liquid from the dispenser pump into the first chamber and the second chamber concurrently.

Clause 128. The method of any of clauses 119-126, further comprising:
aspirating a fifth volume of liquid with a first aspirator, the first aspirator defining a third chamber and including a third piston configured to slide at least partially within the third chamber, a third nozzle coupled with the third chamber, and a fifth one-way valve in fluidic communication with the third chamber for allowing a liquid flow into the third chamber through the fifth one-way valve and restricting a liquid flow out of the third chamber through the fifth one-way valve, wherein the fifth volume of liquid is aspirated with the first aspirator by moving the third piston; and
aspirating a sixth volume of liquid with the first aspirator using an aspirator pump in fluidic communication with the third chamber to move liquid from the third chamber, wherein the sixth volume is distinct from the fifth volume.

Clause 129. The method of clause 128, wherein the fifth one-way valve is located between the third chamber and the third nozzle to allow a liquid flow into the third chamber through the fifth one-way valve and restrict a liquid flow out of the third chamber to the third nozzle through the fifth one-way valve.

Clause 130. The method of clause 128 or 129, wherein:
the first aspirator also includes a sixth one-way valve in fluidic communication with the third chamber for allowing a liquid flow from the third chamber to the aspirator pump through the sixth one-way valve and restrict a liquid flow into the third chamber from the aspirator pump through the sixth one-way valve.

Clause 131. The method of any of clauses 128-130, wherein the sixth volume is greater than the fifth volume.

Clause 132. The method of any of clauses 128-131, further comprising:
aspirating a seventh volume of liquid with a second aspirator defining a fourth chamber, the second aspirator including a fourth piston configured to slide at least partially within the fourth chamber, a fourth nozzle coupled with the fourth chamber, and a seventh one-way valve in fluidic communication with the fourth chamber for allowing a liquid flow into the fourth chamber through the seventh one-way valve and restricting a liquid flow out of the fourth chamber through the seventh one-way valve, wherein the seventh volume of liquid is aspirated with the second aspirator by moving the fourth piston; and
aspirating an eighth volume of liquid with the second aspirator using the aspirator pump in fluidic communication with the fourth chamber to move liquid from the fourth chamber, wherein the eighth volume is distinct from the seventh volume.

Clause 133. The method of clause 132, wherein the seventh one-way valve is located between the fourth chamber and the fourth nozzle to allow a liquid flow into the fourth chamber from the fourth nozzle through the seventh one-way valve and restrict a liquid flow out of the fourth chamber to the fourth nozzle through the seventh one-way valve.

Clause 134. The method of clause 132 or 133, wherein:
the second aspirator also includes an eighth one-way valve in fluidic communication with the fourth chamber for allowing a liquid flow from the fourth chamber to the aspirator pump through the eighth one-way valve and restricting a liquid flow into the fourth chamber from the aspirator pump through the eighth one-way valve.

Clause 135. The method of any of clauses 132-134, wherein the eighth volume is greater than the seventh volume.

Clause 136. The method of any of clauses 132-135, including:
aspirating liquid into the third chamber and the fourth chamber concurrently using the aspirator pump.

Clause 137. The method of any of clauses 128-136, wherein:
the aspirator pump includes a vacuum pump.

Clause 138. A method, comprising:
aspirating a first volume of liquid with a first aspirator defining a first chamber and including a first piston configured to slide at least partially within the first chamber, a first nozzle coupled with the first chamber, and a first one-way valve in fluidic communication with the first chamber for allowing a liquid flow into the first chamber through the first one-way valve and restricting a liquid flow out of the first chamber through the first one-way valve, wherein the first volume of liquid is aspirated with the first aspirator by moving the first piston; and
aspirating a second volume of liquid with the first aspirator using an aspirator pump in fluidic communication with the first chamber to move liquid from the first chamber, wherein the second volume is distinct from the first volume.

Clause 139. The method of clause 138, wherein the first one-way valve is located between the first chamber and the first nozzle to allow a liquid flow into the first chamber through the first one-way valve and restrict a liquid flow out of the first chamber to the first nozzle through the first one-way valve.

Clause 140. The method of clause 138 or 139, wherein:
the first aspirator also includes a second one-way valve in fluidic communication with the first chamber for allowing a liquid flow from the first chamber to the aspirator pump through the second one-way valve and restrict a liquid flow into the first chamber from the aspirator pump through the second one-way valve.

Clause 141. The method of any of clauses 138-140, wherein the second volume is greater than the first volume.

Clause 142. The method of any of clauses 138-141, further comprising:
aspirating a third volume of liquid with a second aspirator defining a second chamber, the second aspirator including a second piston configured to slide at least partially within the second chamber, a second nozzle coupled with the second chamber, and a third one-way valve in fluidic communication with the second chamber for allowing a liquid flow into the second chamber through the third one-way valve and restricting a liquid flow out of the second chamber through the third one-way valve, wherein the third volume of liquid is aspirated with the second aspirator by moving the second piston; and
aspirating a fourth volume of liquid with the second aspirator using the aspirator pump in fluidic communication with the second chamber to move liquid from the second chamber, wherein the fourth volume is distinct from the third volume.

Clause 143. The method of clause 142, wherein the third one-way valve is located between the second chamber and the second nozzle to allow a liquid flow into the second chamber from the second nozzle through the third one-way valve and restrict a liquid flow out of the second chamber to the second nozzle through the third one-way valve.

Clause 144. The method of clause 142 or 143, wherein:
the second aspirator also includes a fourth one-way valve in fluidic communication with the second chamber for allowing a liquid flow from the second chamber to the aspirator pump through the fourth one-way valve and restrict a liquid flow into the second chamber from the aspirator pump through the fourth one-way valve.

Clause 145. The method of any of clauses 142-144, wherein the fourth volume is greater than the third volume.

Clause 146. The method of any of clauses 142-145, including:
aspirating liquid into the first chamber and the second chamber to the aspirator pump concurrently using the aspirator pump.

Clause 147. The method of any of clauses 138-146, wherein:
the aspirator pump includes a vacuum pump.

1. An apparatus for washing a sample in a sample liquid in a well on a plate, the apparatus comprising:
a dispenser with a dispenser nozzle for dispensing a wash liquid to the sample liquid;
a dispenser actuator coupled with the dispenser nozzle;
one or more processors; and
memory storing instructions for execution by the one or more processors, the stored instructions including instructions for sending one or more signals to the dispenser actuator for placing a tip of the dispenser nozzle in contact with the sample liquid at a location adjacent to a top liquid surface of the sample liquid for dispensing the wash liquid through the dispenser nozzle.

2. The apparatus of claim 1, wherein:
the stored instructions include instructions for sending one or more signals to the dispense actuator for placing the tip of the dispenser nozzle within a predefined distance, below the top liquid surface of the sample liquid.

3. The apparatus of claim 1, wherein:
a dispensing rate for dispensing the wash liquid through the dispenser nozzle is less than a predefined dispense rate.

4. The apparatus of claim 1, wherein:
the stored instructions include instructions for sending one or more signals to the dispenser for dispensing the wash liquid at different dispensing rates based on a height of the tip of the dispenser nozzle.

5. The apparatus of claim 1, wherein the stored instructions include instructions for sending one or more signals to the dispenser for dispensing the wash liquid at a first dispensing rate at a first height of the tip of the dispenser nozzle and instructions for sending one or more signals to the dispenser for dispensing the wash liquid at a second dispensing rate distinct from the first dispensing rate at a second height of the tip of the dispenser nozzle that is distinct from the first height.

6. The apparatus of claim 5, wherein the first height is greater than the second height and the first dispensing rate is greater than the second dispensing rate.

7. The apparatus of claim 5, wherein the stored instructions also include instructions for sending one or more signals to the dispenser for dispensing the wash liquid at a third dispensing rate distinct from the first dispensing rate and the second dispensing rate at a third height of the tip of the dispenser nozzle distinct from the first height and the second height.

8. The apparatus of claim 7, wherein the second height is greater than the third height and the second dispensing rate is greater than the third dispensing rate.

9. The apparatus of claim 1, wherein:
the dispenser nozzle is positioned to be adjacent to a lateral center of the well.

10. The apparatus of claim 1, wherein:
the tip of the dispenser nozzle is angled toward a wall of the well.

11. The apparatus of claim 1, further comprising:
an aspirator with an aspirator nozzle for aspirating a liquid from the sample liquid.

12. The apparatus of claim 11, further comprising:
an aspirator actuator coupled with the aspirator nozzle,
wherein the stored instructions include instructions for sending one or more signals to the aspirator actuator for placing a tip of the aspirator nozzle.

13. The apparatus of claim 12, wherein:
the stored instructions include instructions for sending one or more signals to the aspirator actuator for:
lowering the aspirator nozzle so that the aspirator nozzle is in contact with the sample solution while the aspirator is aspirating the liquid from the sample solution;
subsequent to lowering the aspirator nozzle, lifting the aspirator nozzle so that the aspirator nozzle ceases to be in contact with a top surface of the sample solution; and
subsequent to lifting the aspirator nozzle, lowering the aspirator nozzle so that the aspirator nozzle is in contact with the sample solution while the aspirator is aspirating the liquid from the sample solution.

14. The apparatus of claim 13, wherein:
the stored instructions include instructions for sending one or more signals to the aspirator actuator for repeating the lifting operation and the lowering operation.

15. The apparatus of claim 11, wherein:
the stored instructions include instructions for sending one or more signals to the aspirator actuator for placing the aspirator nozzle within a predefined distance from the top surface of the sample.

16. The apparatus of claim 11, wherein:
the aspirator nozzle is positioned relative to the dispenser nozzle so that a height of the aspirator nozzle is greater than a height of the dispenser nozzle, or the height of the aspirator nozzle is substantially the same as the height of the dispenser nozzle.

17. The apparatus of claim 11, wherein:
an aspiration rate for aspirating the liquid through the aspirator nozzle is less than a predefined aspiration rate.

18. The apparatus of claim 11, wherein:
the stored instructions include instructions for sending one or more signals to the aspirator for aspirating the liquid at different aspiration rates based on a height of the tip of the aspirator nozzle.

19. The apparatus of claim 11, wherein the stored instructions include instructions for sending one or more signals to the aspirator for aspirating the liquid at a first aspiration rate at a first height of the tip of the aspirator nozzle and instructions for sending one or more signals to the aspirator for aspirating the liquid at a second aspiration rate distinct from the first aspiration rate at a second height of the tip of the aspirator nozzle that is distinct from the first height.

20. (canceled)

21. (canceled)

22. (canceled)

23. (canceled)

24. The apparatus of claim 11, wherein the stored instructions include instructions for moving the aspirator nozzle laterally as a function of a height of the aspirator nozzle.

25. (canceled)

26. (canceled)

27. (canceled)
